(19) United States
(12) Patent Application Publication
(10) Pub. No.: US 2015/0235332 A1
(43) Pub. Date: Aug. 20, 2015

(54) REALTOR-CLIENT CONNECTION SOLUTIONS

(71) Applicant: 10 MINUTE REALTY, LLC., SUGAR LAND, TX (US)

(72) Inventors: EDIT SZAMOS STYVE, SUGAR LAND, TX (US); RINA ESQUENAZI CAMHI, HOUSTON, TX (US); RAFAEL CAMHI ESQUENAZI, HOUSTON, TX (US)

(21) Appl. No.: 14/544,356

(22) Filed: Dec. 29, 2014

Related U.S. Application Data
(60) Provisional application No. 61/921,887, filed on Dec. 30, 2013.

(51) Int. Cl. G06Q 50/16; G06Q 30/06; H04W 4/02; G06Q 10/06

(52) U.S. Cl. CPC G06Q 50/16; G06Q 10/06311; G06Q 30/0613; H04W 4/023

(57) ABSTRACT

Methods and systems for providing potential property buyers with prompt access to available realtors are disclosed. A system user may request a showing of a selected property by a realtor within a predetermined amount of time. The system can determine or estimate the amount of time it will take for an agent to arrive at the user's location or the location of the selected property. The device can provide this information and request confirmation that the user would like a realtor to come to the desired location. If the user confirms her desire for a showing, a request will be sent to at least one realtor. If the realtor agrees to provide a showing to the user, the client is notified. The system can continue to send requests to realtors which are farther and farther away from the user until a realtor agrees to provide the requested showing.

### CROSS-REFERENCE TO RELATED APPLICATION

This application claims priority benefit of U.S. Provisional Application No. 61/921,887, filed Dec. 30, 2013, the contents of which are entirely incorporated by reference herein.

### REFERENCE TO COMPUTER PROGRAM LISTING APPENDIX

This application incorporates by reference the file entitled 10MinRealty on the compact disc, the size of which is 46.4 megabytes, created on Dec. 2, 2014, which is located on the compact disc, created on Mar. 26, 2014 bearing the following docket number: 34222.0001.NPUS00.

### FIELD

The subject matter herein generally relates to providing potential property buyers with prompt access to available realtors.

### BRIEF DESCRIPTION OF THE DRAWINGS

Implementations of the present technology will now be described, by way of example only, with reference to the attached figure, wherein:

FIG. 1 illustrates a method of locating a realtor to provide a showing;

FIG. 2 illustrates an agent login screen;

FIG. 3 illustrates an agent application menu;

FIG. 4 illustrates an agent pending requests screen;

FIG. 5 illustrates an agent request action screen;

FIG. 6 illustrates an agent customer confirmation;

FIG. 7 illustrates an agent active request screen;

FIG. 8 illustrates an agent profile screen;

FIG. 9 illustrates an agent settings screen;

FIG. 10 illustrates an agent feedback screen;

FIG. 11 illustrates a client Instant Showing screen prior to login;

FIG. 12 illustrates a reverse geocoding screen before login;

FIG. 13 illustrates a customer login screen;

FIG. 14 illustrates a screen for finding a realtor in a neighborhood;

FIG. 15 illustrates an active request for a showing;

FIG. 16 illustrates a confirmed found realtor screen 1600;

FIG. 17 illustrates menu screen;

FIG. 18 illustrates a user profile screen;

FIG. 19 illustrates a user feedback screen;

FIGS. 20A-D illustrate a sequence diagram corresponding to a method of locating a realtor;

FIG. 21 illustrates a block diagram of an electronic device; and

FIG. 22 illustrates a system-control unit for an electronic device.

### DETAILED DESCRIPTION

For simplicity and clarity of illustration, where appropriate, reference numerals have been repeated among the different figures to indicate corresponding or analogous elements. In addition, numerous specific details are set forth in order to provide a thorough understanding of the implementations described herein. However, the implementations described herein can be practiced without these specific details. In other instances, methods, procedures and components have not been described in detail so as not to obscure the related relevant feature being described. Also, the description is not to be considered as limiting the scope of the implementations described herein.

Several definitions that apply throughout this disclosure will now be presented. The term coupled is defined as directly or indirectly connected to one or more components. The term server can include a hardware server and a virtual machine. The term client is defined as a potential buyer or renter of a building or property and any device used by such person. The term realtor is defined as a person or party who is properly qualified to sell real estate or property. The term user can include clients, potential clients, realtors and/or potential realtors.

In at least one embodiment, the present technology can be implemented as a software module or a hardware module, or both. In at least one embodiment, the present technology causes a processor to execute instructions. The software module can be stored within a memory device or a drive.

The present technology is configured to provide fast and efficient ways to enable a client to locate and identify a realtor who is able to show a home or property that the client would like to view. In at least one embodiment, the client will be presented with a realtor who is able to arrive at a location chosen by a client within a predetermined set time. The predetermined set time can, for example, be ten minutes, twenty minute, thirty minutes or another suitable length of time. In at least one embodiment, the client will be presented with a realtor who is able to arrive at a location chosen by a client within twenty minutes. In at least one embodiment, the client will be presented with a realtor who is able to arrive at a location chosen by a client within thirty minutes. In at least one embodiment, a user-client can be provided the opportunity to determine the maximum distance for a potential realtor or a maximum amount of time for a potential realtor.

In at least one embodiment, a software application can be downloaded to and executed by an electronic device such as tablet computer or smart phone. In at least one embodiment, the activities of electronic devices running such software can be tracked and administered by a server computer in signal communication with such devices. In at least one embodiment, a Software-as-Service model can enable applications to be hosted as a single system, providing services to multiple buyers, agents, brokerage firms and multiple-regional markets. In at least one embodiment, users and firms can sign up through a web or mobile interface and manage their own accounts.

In at least one embodiment, realtors can register to be notified by clients if certain criteria are met. Registration can be fee based. In at least one embodiment, realtors can be compensated for successfully rendezvousing with a client within a predetermined amount of time. In at least one embodiment, users can be charged subscription fees for using systems described herein. In at least one embodiment, subscriptions can involve credit card authorization and a checkout process with automatic recurring payments. In at least one embodiment, users can cancel a subscription to a service such as those described herein.

In at least one embodiment, new users of a system or application can be required to register before they can request a showing of a property. Registration is simple and user-friendly; in at least one embodiment, confirmation of registration is sent to a client via email. In at least one embodiment, each user can be provided with a unique login password. Entering the login password can confirm that the user is a properly registered user who is allowed to utilize the systems and applications.

In at least one embodiment, a user-interface of an electronic device can render a dashboard. The dashboard can include landing screen to provide a general overview and status information to the user. The dashboard can orient the user, giving the user a central location from which to access various features. At least one feature is a map. The map can display the user's current location as well as the location and identities of nearby agents (realtors). The map can also display those properties which have been previously viewed by the user. In at least on embodiment, the map can also display the user's favorite properties.

In at least one embodiment, a dashboard board can also provide additional functionality with regard to the properties viewed as discussed above. For example, the dashboard can provide a quick link from the map view to display listing information, pictures, and other useful information. The dashboard can include button bar navigation which enables a user to filters filter properties based on criteria such as price, size, and the number of rooms. Button bar navigation can also enable a user to view information such as demographic information and information about schools near a property in question. In at least one embodiment, a dashboard can also enable a user to establish personal information, including home-buying preferences.

In at least one embodiment, a user is enabled to search for homes based on specific keywords. Keyword searching can enable searching based on terms that may not be appropriate to include as filters. Search terms could include, desert landscape, modern, colonial, custom home, etc. In at least one embodiment, keywords can be used in conjunction with other search criteria, as will be discussed below.

In at least one embodiment, optional filters can be used to the properties listed to only those that match search criteria including, but not limited to: zip code, price range, square footage, lot size, number of stories, number of bedrooms, number of bathrooms and garage size.

In at least one embodiment, once a search has been performed using some or all of the criteria and filters described above, a device can render a list of suitable properties. Results can be displayed as a pinned map or text listing. In at least one embodiment, maps can display the user's current location with homes matching search and filter criteria displayed as pins on the map. In at least one embodiment, tapping a pin can cause information and options to be displayed. In at least one embodiment, a map can have auto zoom functionality. Auto zoom functionality enables a device-user to cause a device to display a maximum number of properties, which can prevent the map from becoming cluttered. In at least one embodiment, this maximum number of displayed properties can be user-selectable. In at least one embodiment, the mapping function can be configured to auto zoom out in more sparsely populated areas to a maximum level set by either the user, or by the system administrator, as appropriate.

In at least one embodiment, instead of, or in addition to, providing a map view as described above, a device can also provide textual list view. In such a textual list view, lists of homes can be sorted and presented according to their proximity to the user's current location. As in the map view discussed above, tapping on a list item can cause additional information and options to be displayed.

In at least one embodiment, a user can select a displayed or listed property. Once a property has been selected the user can have the option of displaying additional information about the property, such as seller information and asking price. The user can also have the option of adding the selected property to her list of favorite properties. The user can also be given the option of excluding the property from any future searches. In at least one embodiment, the user can request that the selected property be shown to the user by a realtor within a predetermined amount of time, as will be discussed in greater detail below.

In at least one embodiment, an electronic device can have a route planning feature. A route planning feature can enable a user to select properties in a specific order and add them to a route plan. Thereafter, driving instructions and timings can be automatically provided to a user.

In at least one embodiment, an electronic device can have an agent contact list feature. Within the agent contact feature, once an agent (or realtor) connects through the system with a buyer, the agent's name, preferences and contact information are stored in in the agent's buyer contact list. This can enable users to text, email or call agents directly from the list. This feature can enable a buyer to view a list of properties shown to them by each agent as and view any notes taken during any such showings. In at least one embodiment, the user can be provided with the option of excluding certain agents from receiving showing request notifications.

In at least one embodiment, a user may request a showing of a selected property by a realtor within a predetermined amount of time, (ten to twenty minutes, for example). As discussed above, the user can select the specific property from a pinned map or from a list of those properties nearby using global positioning system (GPS). In at least one embodiment, the user may be given the option of entering a physical address into the electronic device. In at least one embodiment, once a desired property has been selected, the user can be provided with various options. For example, the user can request an agent. If the user requests an agent, the system can determine or estimate the amount of time it will take for an agent to arrive at the user's location or the location of the selected property. The device can provide this information and request confirmation that the user would like a realtor to come to the desired location. For example, an electronic device can display a message such as: “There are 8 agents current within 10 to 20 minutes from here. Would you like to request an agent to come show you the house now?” If the user confirms her desire for a showing, a request will be sent to at least one realtor, as will be discussed in greater detail below.

In at least one embodiment, once the user confirms the user's desire for a showing, the system will begin to display status updates to the user and begin the process of sending notifications to agents in periodically increasing concentric circles based on the proximity of realtors to the user. This process can give the greatest chance to provide the desired showing to those agents closest in proximity, while periodically expanding the radius to include agents farther away. This process can therefore beneficial to both the user and the realtors in question. During the process of sending show-requests to realtors, status updates can be provided to the user of the device running an application of this disclosure. Example status updates can include: “Checking with agents who are within 10 minutes arrival time . . . ”; (after 30 seconds have elapsed), “Expanding search to agents within 15 minutes arrival time . . . ”; and (after 60 seconds have elapsed), “Expanding search to agents within 20 minutes arrival time . . . ”.

In at least one embodiment, once an agent (realtor) confirms her desire to provide the requested showing, the user is updated with a message indicating that the agent has confirmed. Such a message could include” “[Agent's Name] will arrive in [x] minutes to show you the house at [address].” In at least one embodiment, a picture of the agent and other relevant information can accompany the message. In at least one embodiment, the buyer can track the agent on a map while the agent is in route.

In at least one embodiment, a GPS-based proximity algorithm is used to determine that the agent has arrived at the selected property location. Once the realtor has arrived, a message can be displayed on the electronic devices of the agent and the buyer, asking them both to confirm that they have connected. In at least one embodiment, a GPS-based arrival tracking algorithm can be used to determine if the confirming agent is delayed more than a reasonable period while in route. If so, the user-device can be configured to display a message such as: “[Agent's Name] is delayed. We found [New Agent], who will arrive in [X] minutes, Please confirm if you want to wait for [New Agent].” Thus, a user is provided with an opportunity to search for a different realtor, should the need arise.

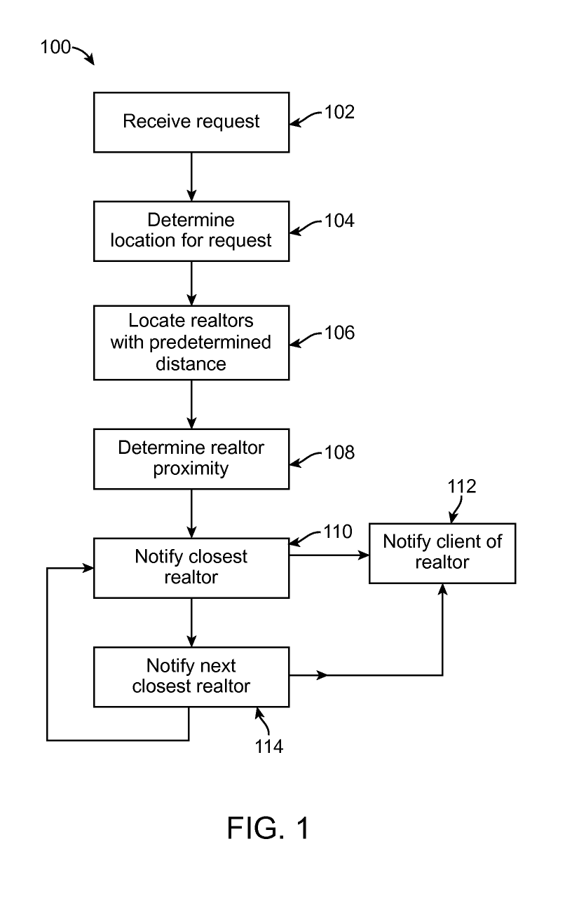

FIG. 1 illustrates a method 100 utilizing the technologies described herein. As illustrated, the method includes several steps. The steps illustrated are for illustration purposes and other steps can be implemented. Additionally, while a particular order is illustrated in FIG. 1, the present technology can be implemented in other arrangements such that the order of the steps can be different than that as illustrated. Furthermore, the present technology can include steps that are not illustrated and other embodiments can be such that one or more of the steps are removed.

The method 100 comprises receiving 102 a request from a client for a showing at a particular location. The method 100 then proceeds to 104, in which the location corresponding to the request is determined. The method 100 then proceeds to 106 in which realtors having a location within a predetermined distance from the location of the client or having an estimated travel time to the location of the client within a predetermined travel time are located. Once the relevant realtors are located, the method proceeds to 108. At 108, the method 100 determines the distances of all the realtors identified in 106. The method 100 then proceeds to 110, in which the closest realtor is notified of the request. If the realtor responds positively to the showing request, the method 100 proceeds to 112, in which the client is notified of the positive response. The method 100 then ends. If the realtor does not respond positively, the method proceeds to 114, in which the next nearest realtor is notified of the showing request. If the realtor responds positively to the showing request, the method 100 proceeds to 112, in which the client is notified of the positive response. The method 100 then ends. The method 100 can continue to notify realtors until the list of all identified realtors is exhausted. In at least one embodiment, if no agent accepts the user's request for a showing within a reasonable period of time, the user can be notified of this fact. The client-user can thereafter be given the opportunity to indicate if she would like an agent to contact them to schedule a showing at a later time. In at least one embodiment, the distance for searching for a realtor can be adjusted, either automatically, or by user selection, and the process of searching for a realtor in the broader area can continue, if the user desires.

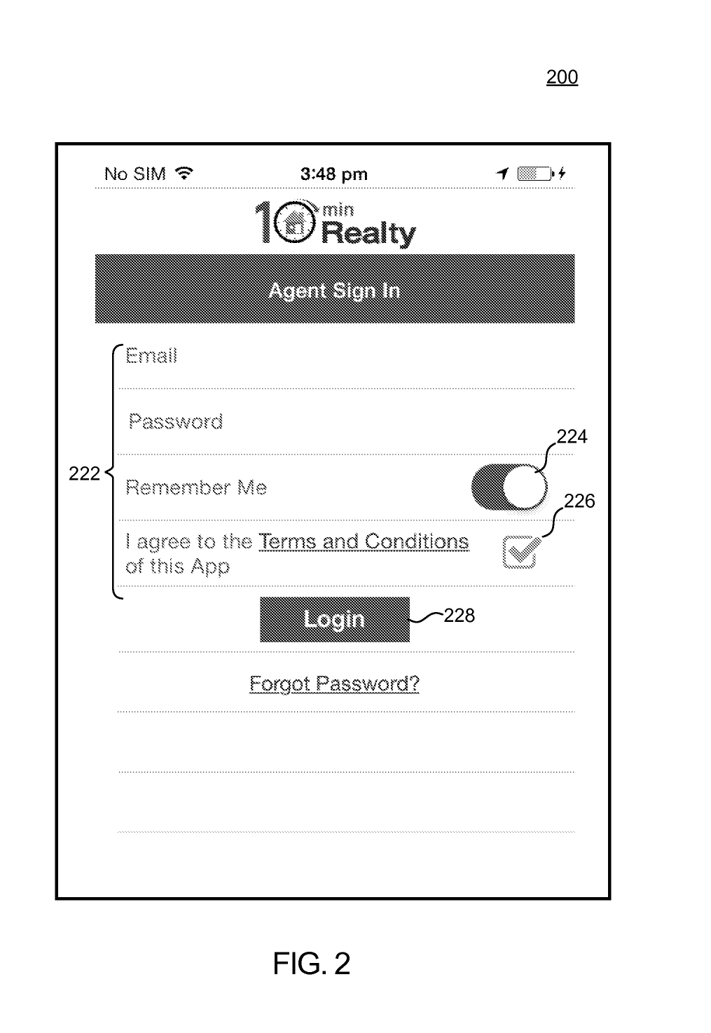

FIG. 2 illustrates an agent login screen 20. The agent login screen 20 can include login input 22 that permits the agent to login. In at least one embodiment, the login input 22 can include email, password, a Remember Me option, and a Terms and Conditions agreement option. The Remember Me option can have a switch 24 where the user can input whether to remain signed in after the application closes. The Terms and Conditions agreement option can have a check box 26 where the user can input whether he or she agrees with the Terms and Conditions. The agent login screen 20 can include a login button 28. If the login input 22 is satisfactory, triggering the login button 28 grants the user access to the application.

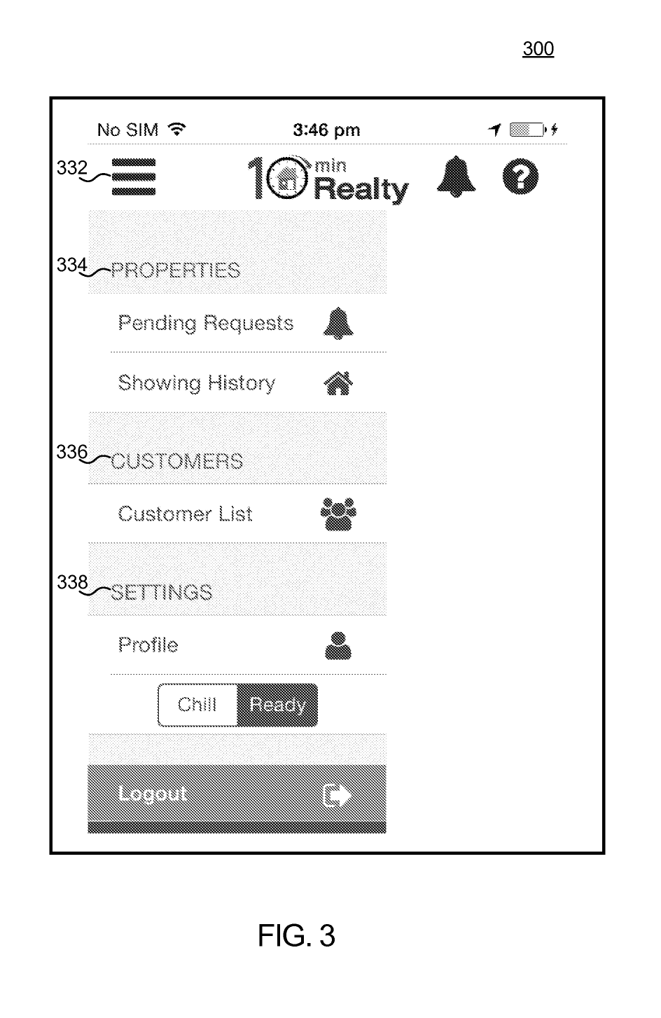

FIG. 3 illustrates an agent application menu 30. The user can trigger a menu icon 32 to access the agent application menu 30. The agent application menu 30 can include a properties submenu 34, a customer's submenu 36, and a settings submenu 38. In the properties submenu 34, the user can access information regarding properties. In at least one embodiment, the properties submenu 34 can include pending requests and showing history. In the customers submenu 36, the user can access a customer list. In the settings submenu 38, the user can access his or her profile information.

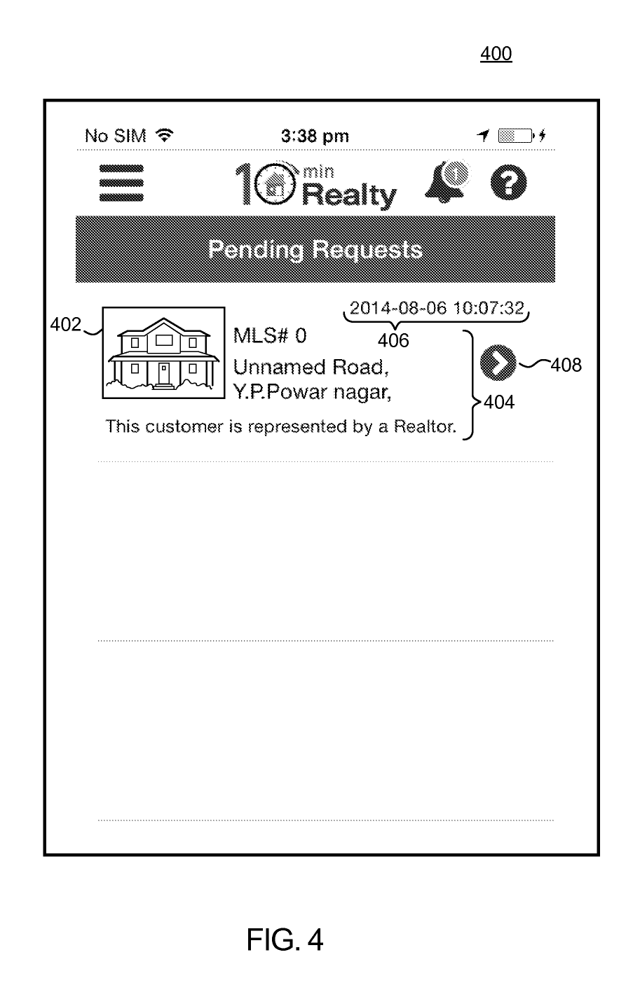

FIG. 4 illustrates an agent pending requests screen 400. The agent pending requests screen 400 can include an image 402 of the house. The agent pending requests screen 400 can include the time and date 406 that the request for an appointment was made. The agent pending requests screen 400 can include property information 404. The property information 404 can include, but is not limited to, the listing number, the address, and whether the customer is represented by a realtor. The user can select the property to access more information by triggering the select button 408.

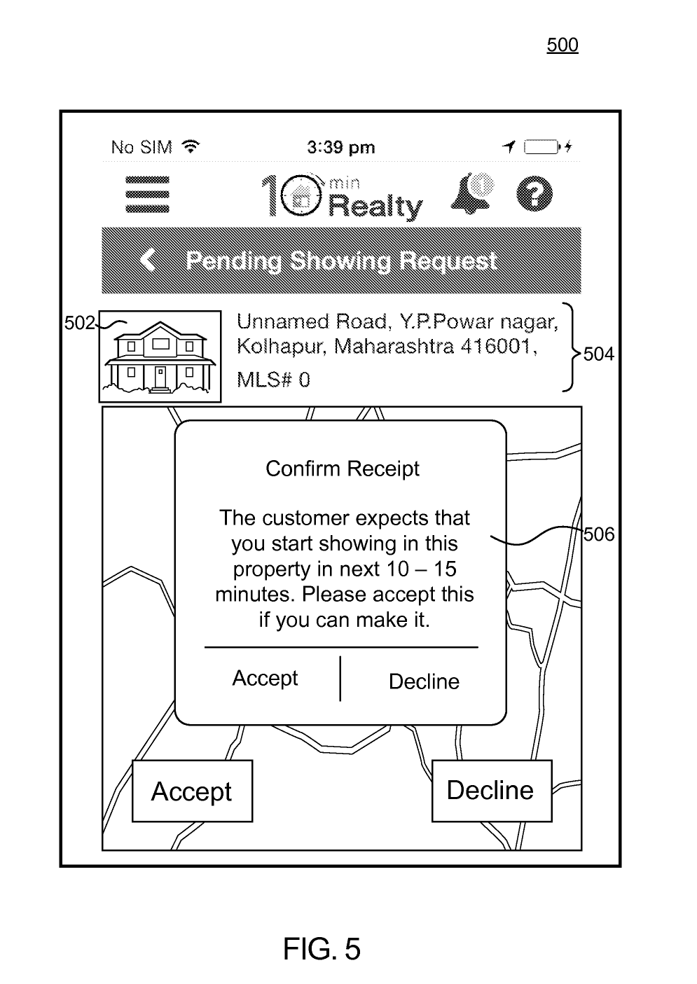

FIG. 5 illustrates an agent request action screen 500. The agent request action screen 500 can include an image 502 of the property. The agent request action screen 500 can include the property information 504 which can include, but is not limited to, the address and listing number of the property. The agent request action screen 500 can display a confirmation screen 506 where the user can decide to accept or decline the request to show the property.

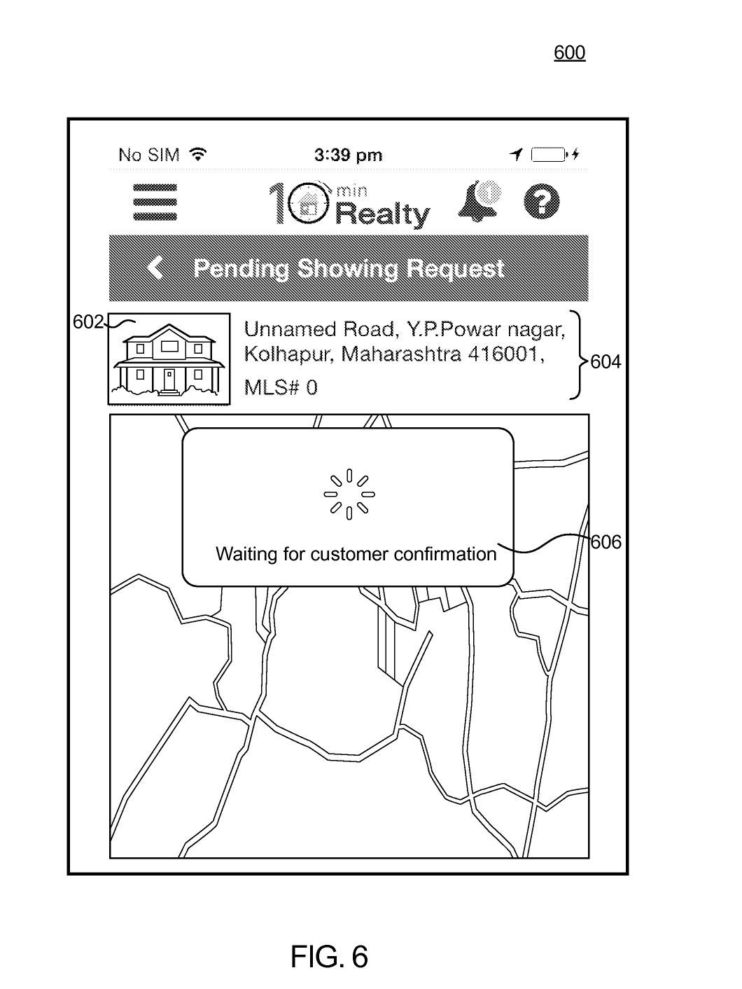

FIG. 6 illustrates an agent customer confirmation screen 600. The customer confirmation screen 600 can include an image 602 of the property. The agent customer confirmation screen 600 can include the property information 604 which can include the address and listing number of the property. When waiting for the customer to confirm the request, an idle screen 606 is displayed.

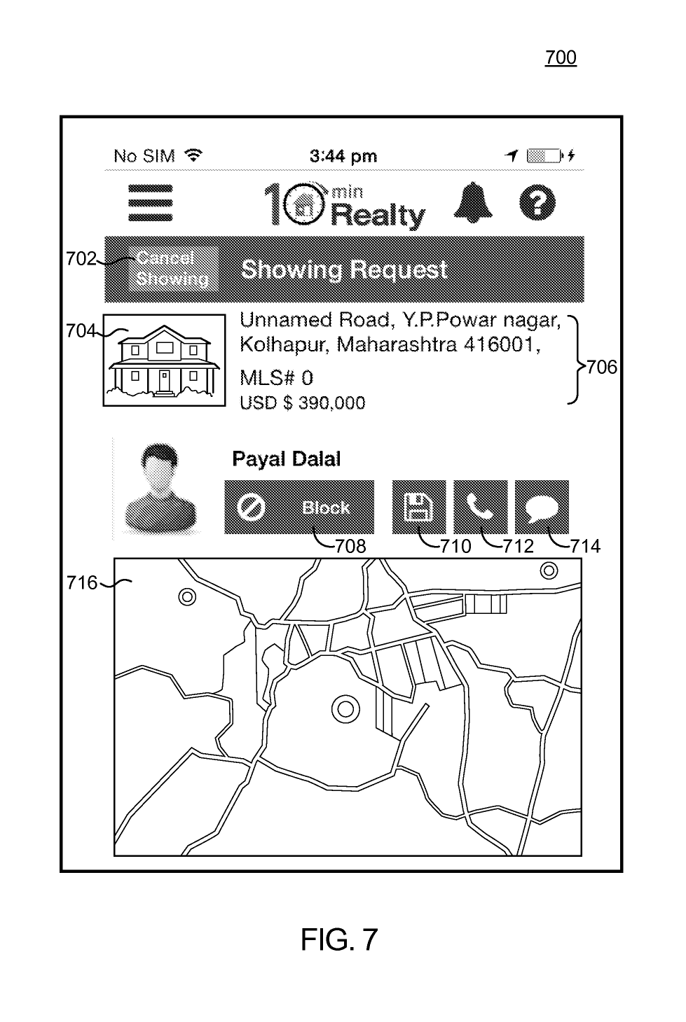

FIG. 7 illustrates an agent active request screen 700. When the user decides not to show the property, the user can trigger the cancel showing button 702 to cancel the appointment with the customer. The agent active request screen 700 can include an image 704 of the property. The agent active request screen 700 can include the property information 706 which can include, but is not limited to, the address, listing number, and listing price of the property. From the agent active request screen 700, the user can block the customer by triggering the block button 708. The user can save the customer information by triggering the save button 710. The user can call the customer by triggering the call button 712. The user can message the customer by triggering the message button 714. The agent active request screen 700 can include a map 716 that displays where the property.

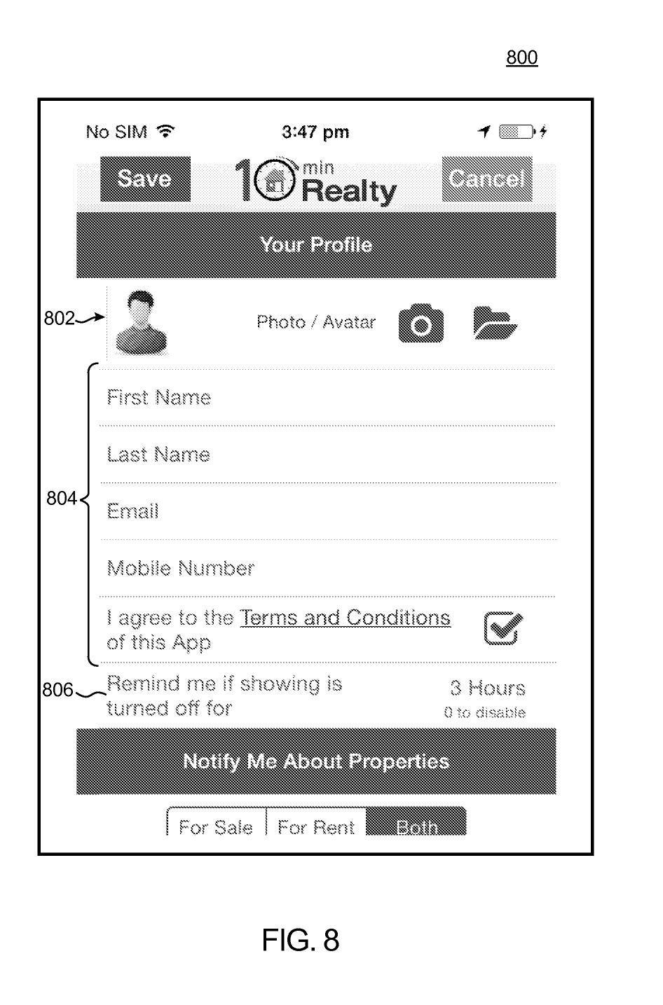

FIG. 8 illustrates an agent Profile screen 800. The agent Profile screen 800 may include an agent Photo/Avatar section 802, an agent personal information section 804, and an agent “Remind Me” section 806. In at least one embodiment, the agent photo or avatar may be changed by triggering the camera icon or folder icon in the agent photo/avatar section 802 of the agent Profile screen 800. In some embodiments agents may store multiple photos or avatars in the folder icon. The Remind Me section 806 allows agents to set a reminder for previously scheduled appointments, wherein the appointment will occur at a predetermined period of time.

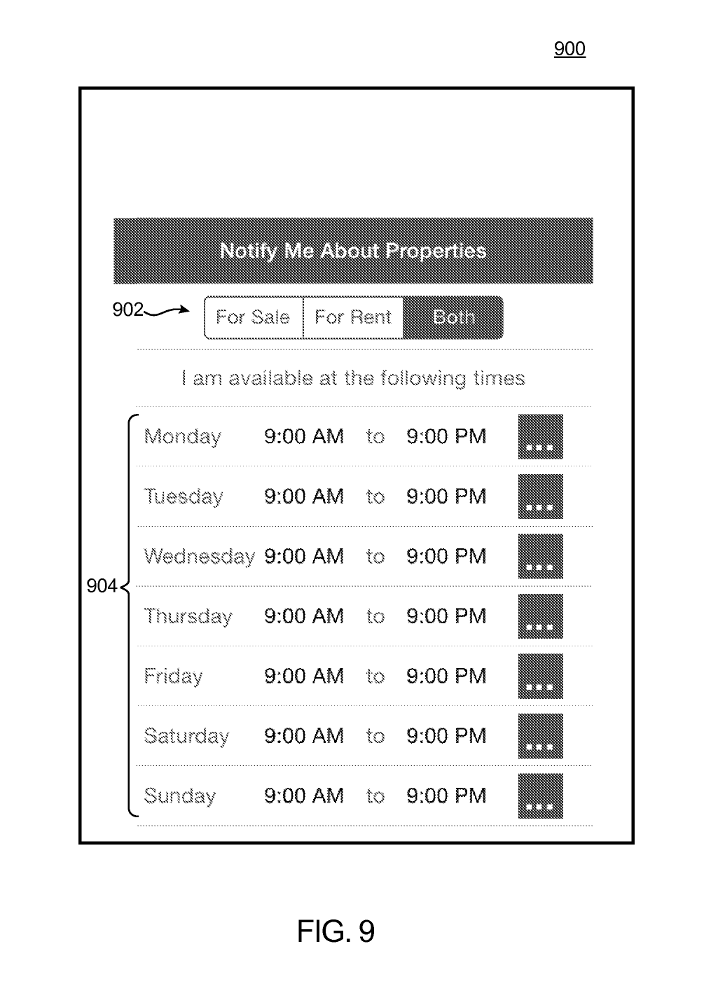

FIG. 9 illustrates an agent settings screen 900. The agent settings screen 900 may include a notification menu 902 and an availability section 904. In at least one embodiment, the notification menu 902 allows agents to have the application notify them when properties come available. These notifications may be set to notify the agent of different occurrences including, but not limited to, houses that come available for sale, houses that come available for rent, and both houses that come available for sale or for rent. In at least one embodiment, agents may use the agent's settings screen 900 to record their availability throughout the week in the availability section 904.

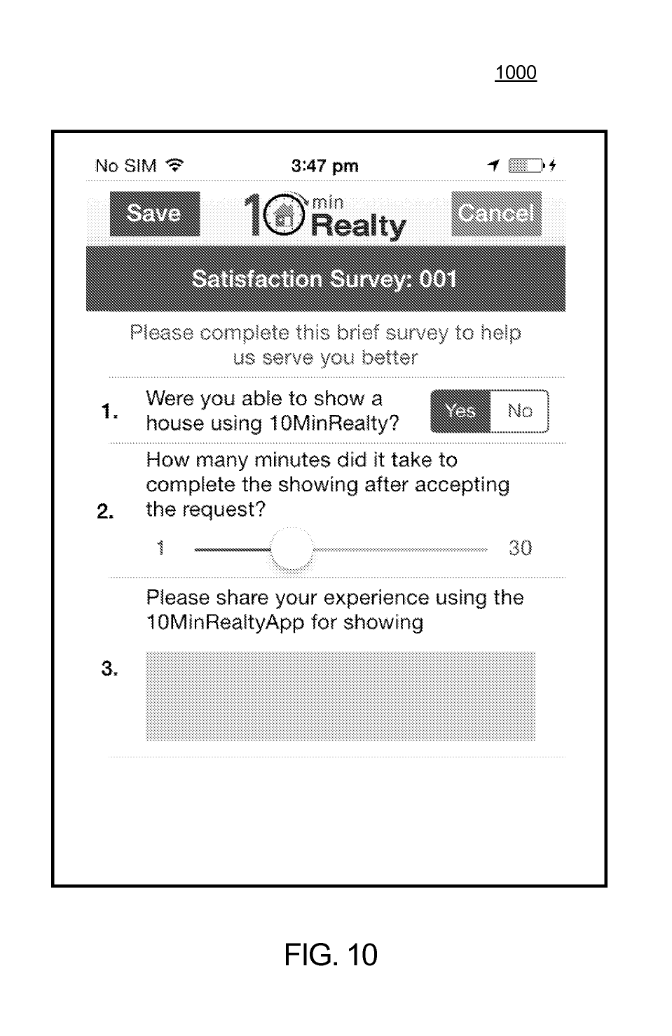

FIG. 10 illustrates an agent feedback screen 1000. In some embodiments, the agent feedback screen 1000 may prompt an agent to respond to a series of questions in order to determine the agent's satisfaction with the application. The questions may cover a variety of topics including, but not limited to, whether or not an agent was able to show a house using the application, how long the showing took to complete after accepting the request from a client, and sharing the experience with other agents.

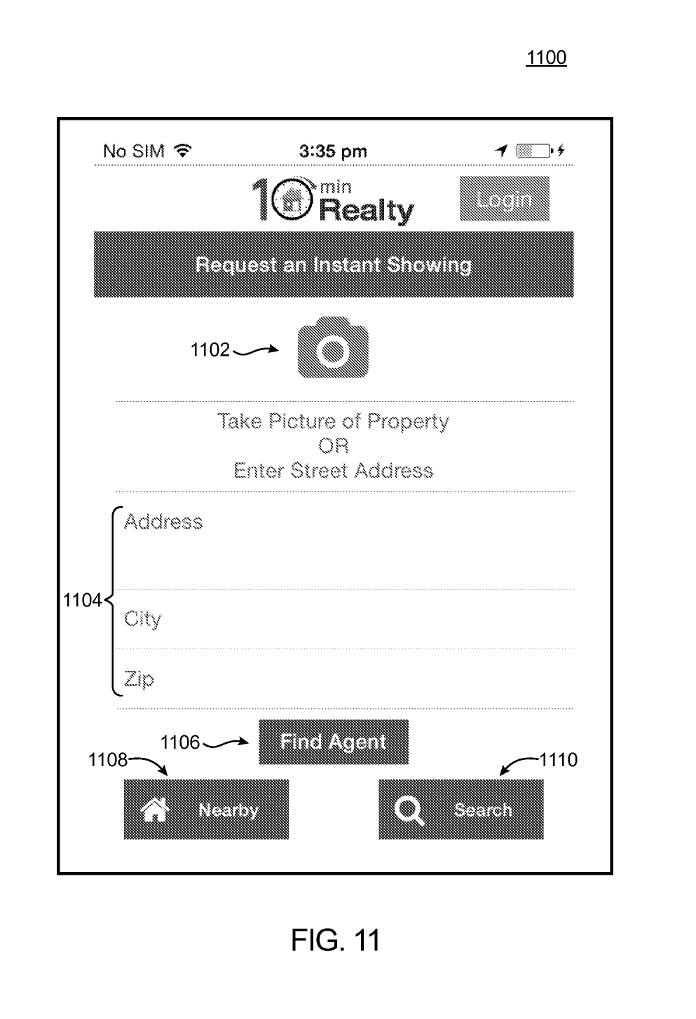

FIG. 11 illustrates a client Instant Showing screen 1100 prior to login. The client Instant Showing screen 1100 may include a camera icon 1102, an address section 1104, an find agent button 1106, a nearby button 1108, and a search button 1110. In some embodiments, when the camera icon 1102 is triggered, the camera on the portable electronic device is triggered, allowing the client to take and upload a photograph of a house they are interested in seeing. The client Instant Showing screen 1100 also provides an address section 1104, wherein a client may enter the address of a house they would like to see. Once the client has either uploaded a photograph or entered a street address, the client may engage the find agent button 1106 to trigger the Application to find a real estate agent that is able to show the client the house. The client may expand their viewing to nearby houses by selecting the nearby button 1108, triggering the application to produce a series of houses for rent or purchase nearby the entered location. A client may begin a new search by triggering the search button 1110.

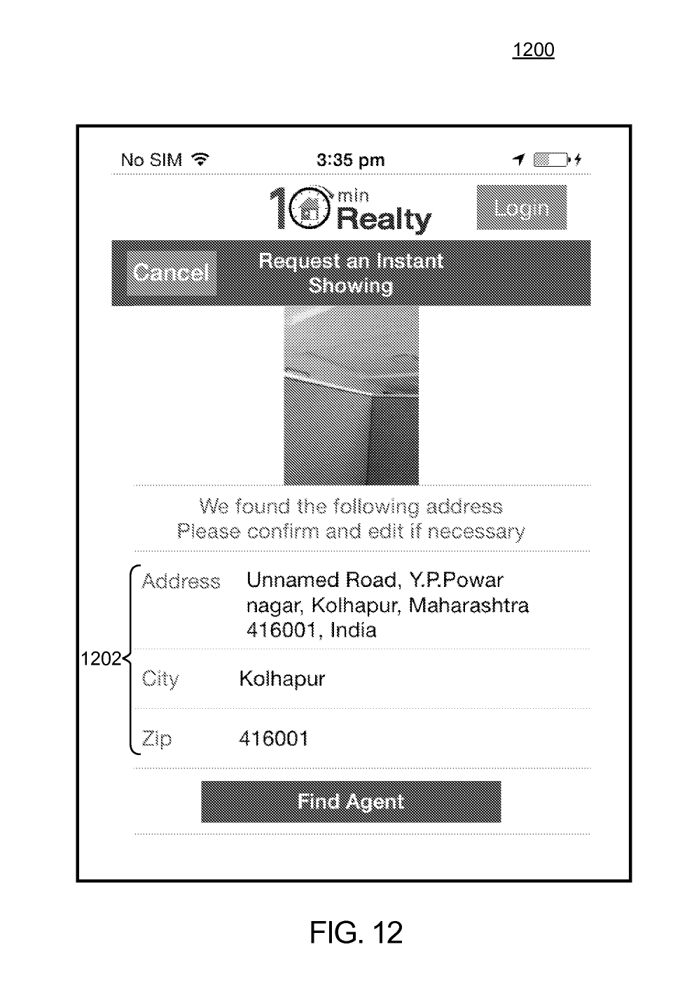

FIG. 12 illustrates a reverse geocoding screen 1200 before login. The reverse geocoding screen 1200 may include an address confirmation section 1202. In at least one embodiment, once a client has uploaded a photograph of a house they would like to view, the application will locate the house using a GPS system. Once the application has located an address for the house, the address will be displayed in the address confirmation section 1202 of the screen for confirmation by the client that the location is accurate.

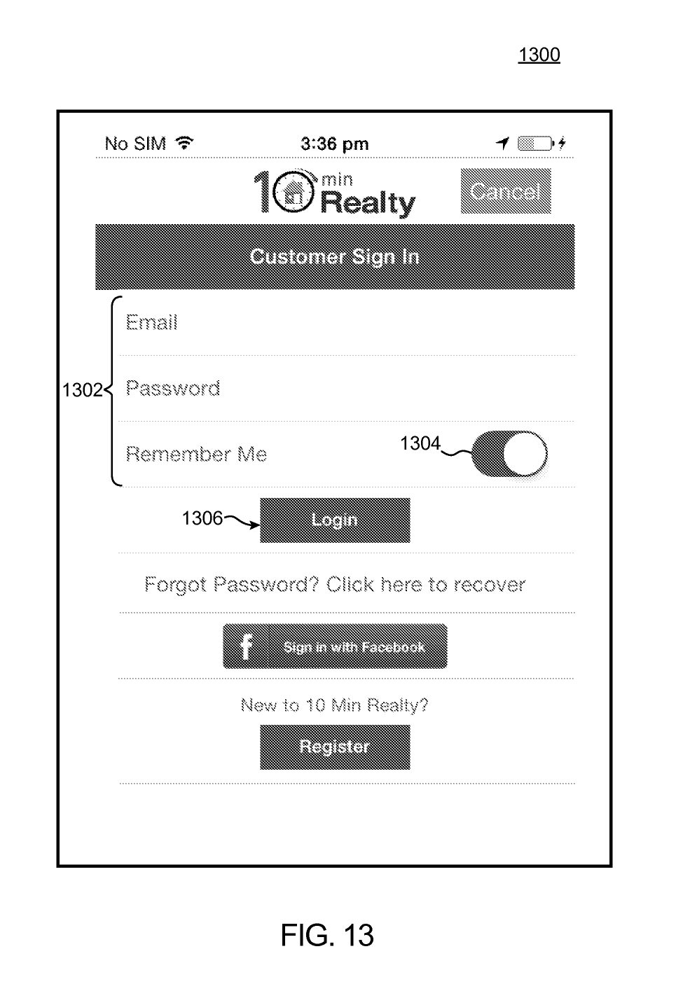

FIG. 13 illustrates a customer login screen 1300. The customer login screen 1300 may include a login section 1302, a “remember me” option, and a login button 1306. In at least one embodiment, the login section 1302 allows a customer to login to a profile using a previously saved email address and password. The remember me option may have a switch 1304 that may be triggered by the user to remain logged into their profile after the application is closed. The customer may complete the login process by selecting the login button 1306 triggering the application to verify the customer information.

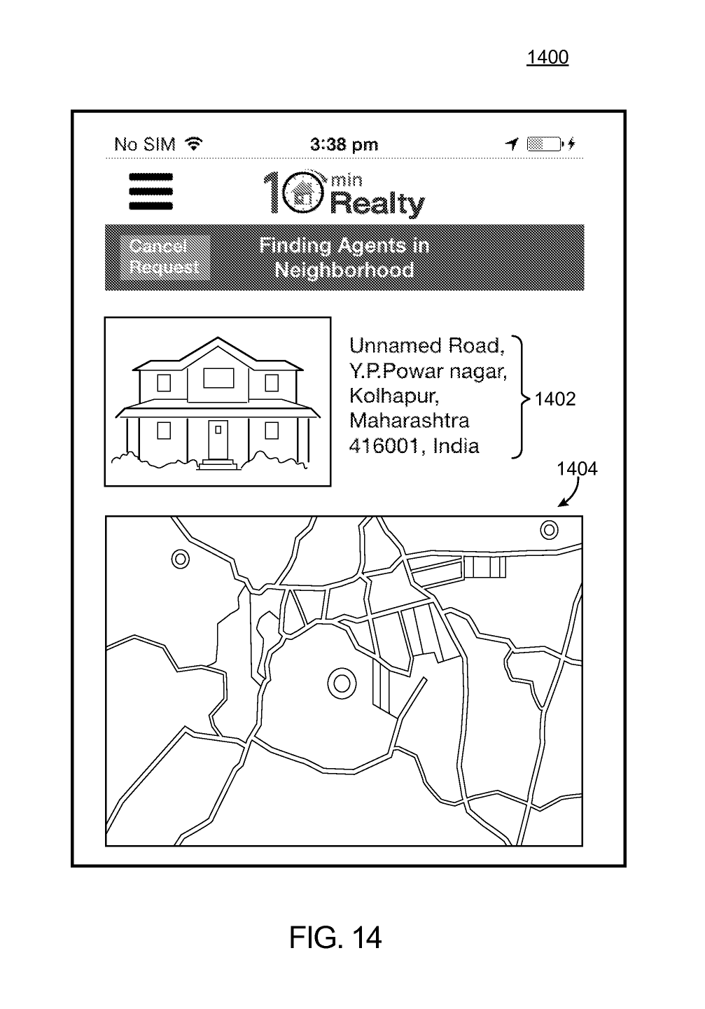

FIG. 14 illustrates a screen for finding a realtor in a neighborhood. The address of the prospective property 1402 can be displayed on a top portion of the dashboard. The top portion of the dashboard can also include a picture of the property. The dashboard can also include a map 1404 showing the user's current location and orientation. The map can further include prospective realtors' locations.

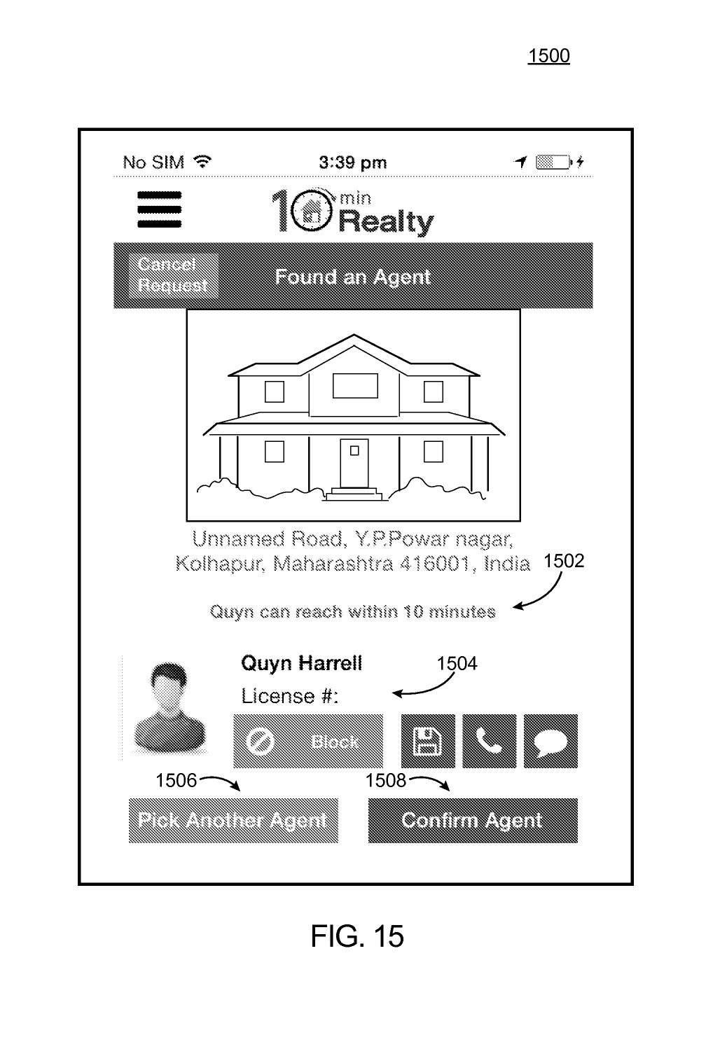

FIG. 15 illustrates an active request 1500 for a showing. The screen can display the estimate time 1502 for an identified realtor to reach the prospective property. The screen 1500 can further display the requested realtor's information 1504 including, but not limited to, name and license number. The realtor's information 1504 can also include a plurality of buttons configured to call the realtor, text the realtor, save the realtor, and block the realtor. The found realtor screen 1500 can further include a button configured to pick another realtor 1506 and a button configured to confirm realtor 1508. In at least one embodiment, the text the realtor button can be configured to operate a chat window, send a text message, or send an e-mail. The screen can further provide a button configured to cancel the requested realtor.

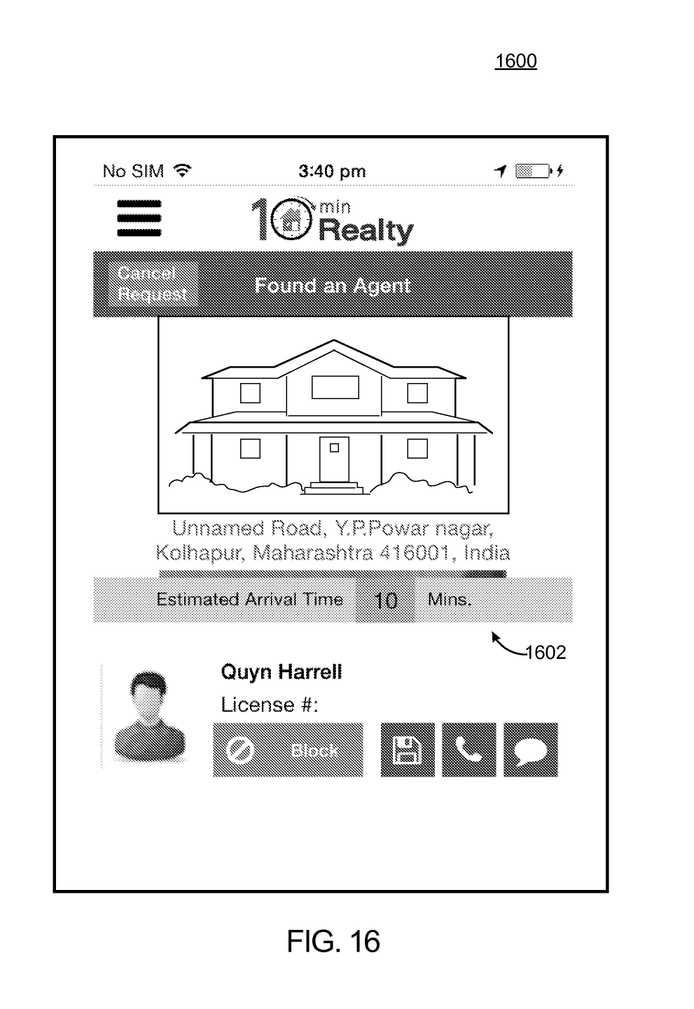

FIG. 16 illustrates a confirmed found realtor screen 1600. The screen 1600 can display the estimated arrival time 1602 in minutes. The screen 1600 can also display the confirmed realtor's information including, but not limited to, name and license number. The realtor's information can also include a plurality of buttons configured to call the realtor, text the realtor, and save the realtor. In at least one embodiment, the text the realtor button can be configured to operate a chat window, send a text message, or send an e-mail.

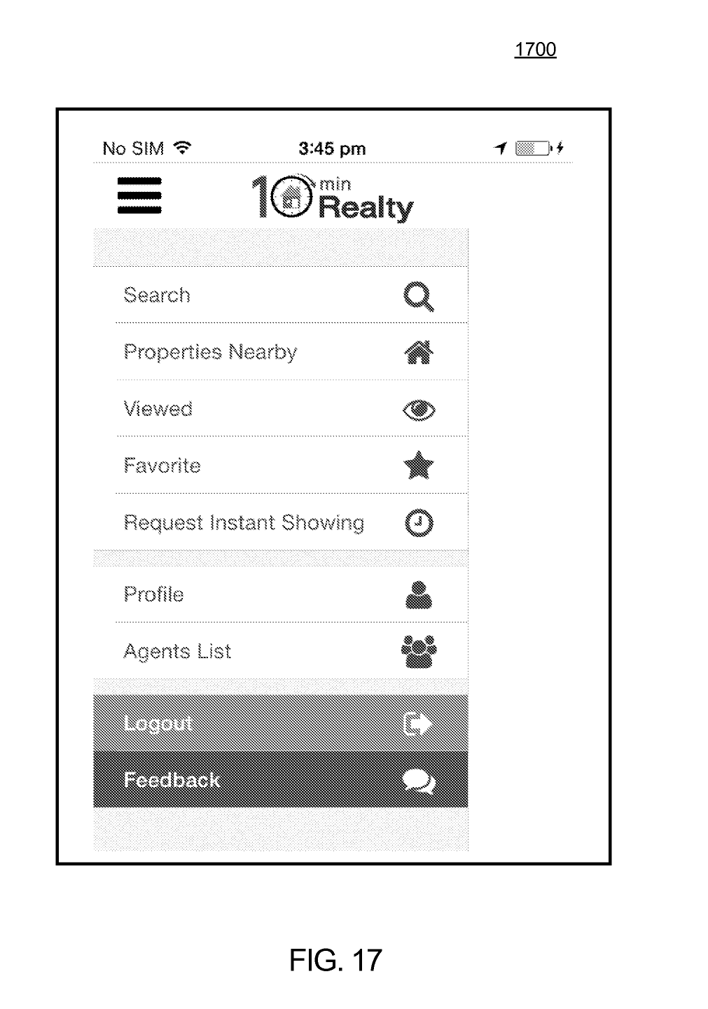

FIG. 17 illustrates menu screen 1700. The menu screen 1700 can display a plurality of options including, but not limited to, search, properties nearby, viewed, favorite, request an instant showing, profile, agents list, logout and feedback. The search option can allow a user to search properties. The properties nearby can allow a user to view properties within a predetermined range from their current location. The viewed option can show a user the properties previously viewed. The favorite option can show a user properties previously selected as favorite. Request an instant showing can allow a user to request a showing of a specific property. The profile option can show a user their profile including their respective information. The agents list can provide a user with a list of agent. The logout option can allow a user to logout of the application. The feedback option can allow a user to provide feedback and rate their experience.

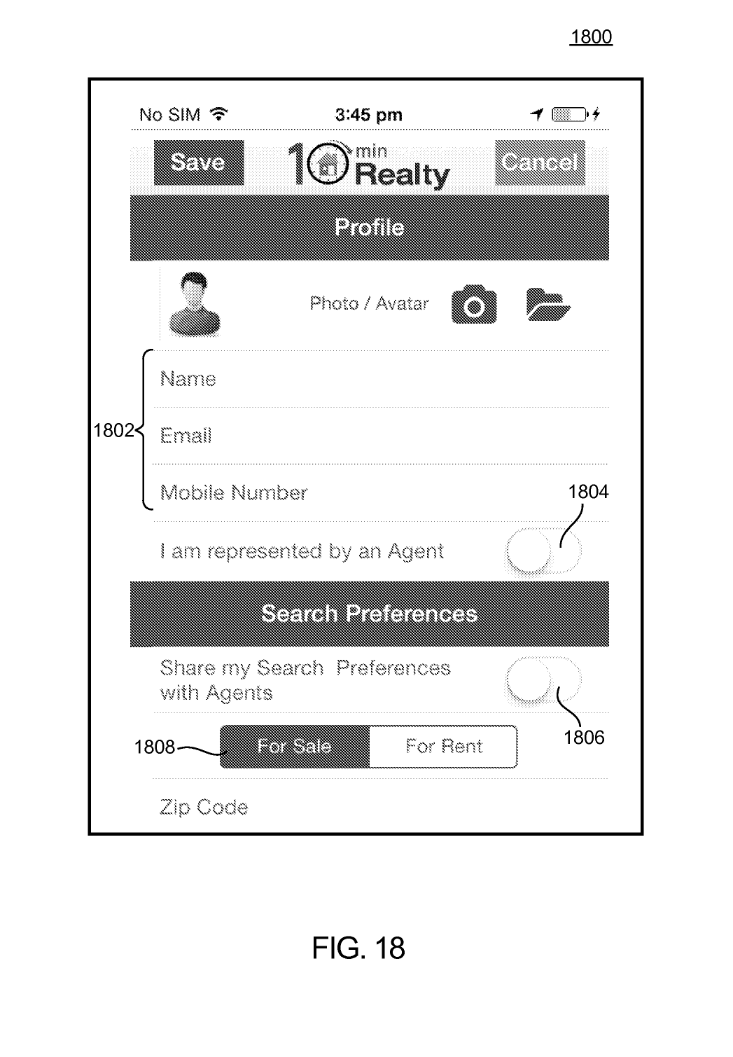

FIG. 18 illustrates a profile screen 1800 showing a user's profile. The profile can include a user's information 1802 including, but not limited to, photograph, name, e-mail, phone number, and whether the user currently has an agent. The profile screen 1800 can also include ability to share or restrict 1806 a user's search preferences from an agent, along with search preferences 1808. Search preferences 1808 can include whether a user is looking for properties for rent or for sale.

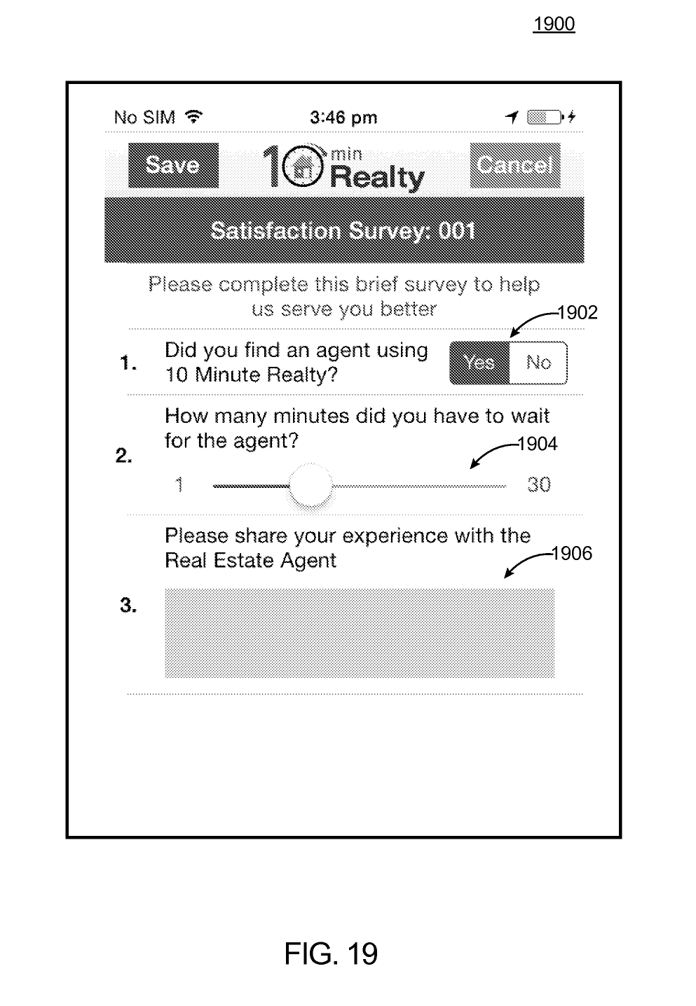

FIG. 19 illustrates a feedback screen 1900. The feedback screen 1900 can include whether a user was able find an agent 1902 using 10 Minute Realty, the user's wait time 1904, and user's experience 1906. In at least one embodiment, the feedback screen 1900 can include additional questions, or have fewer questions.

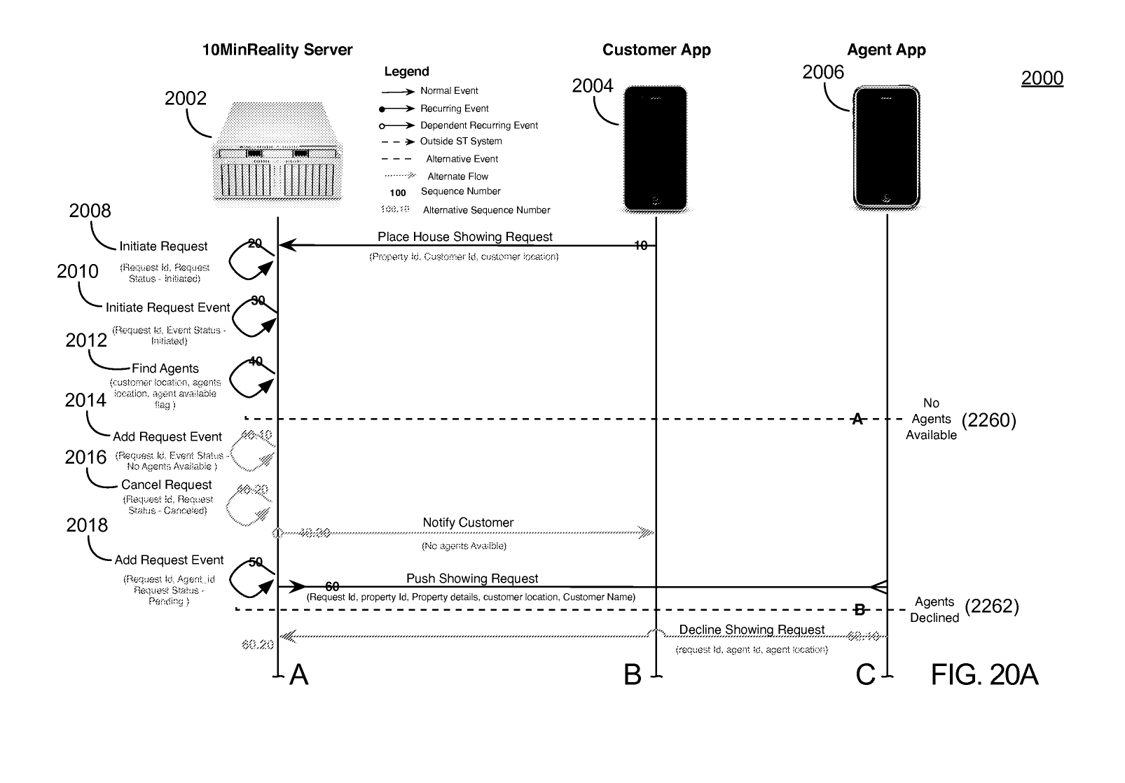

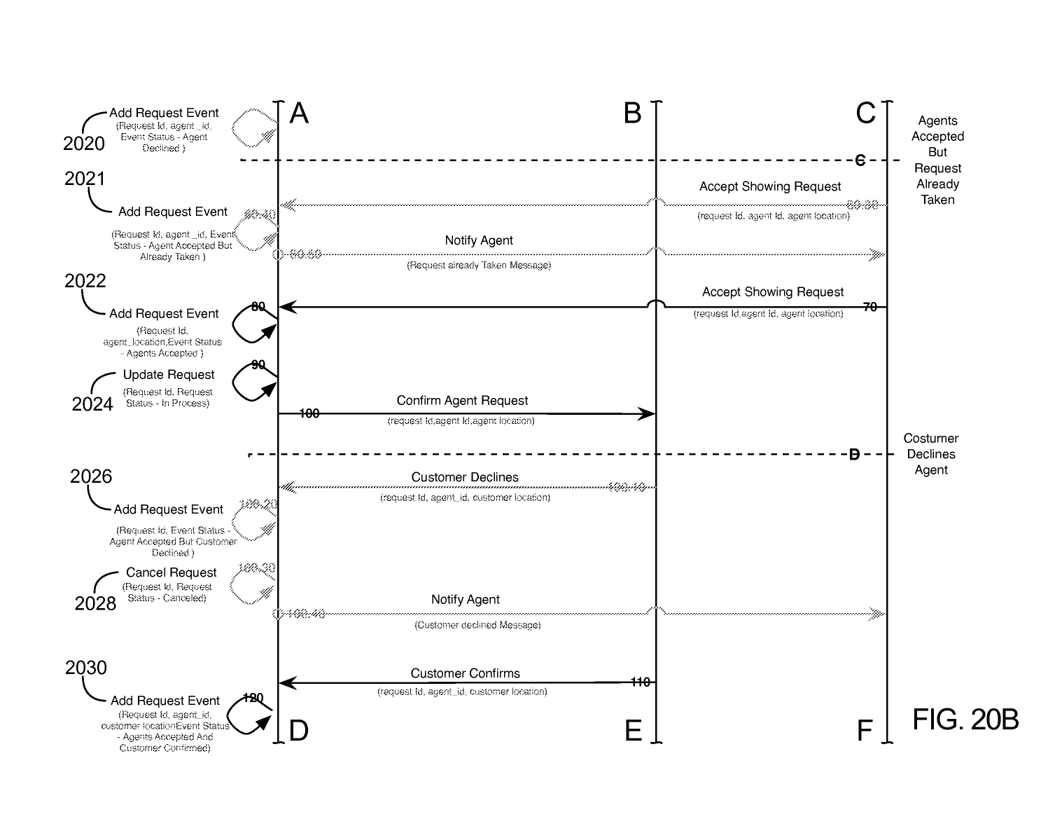

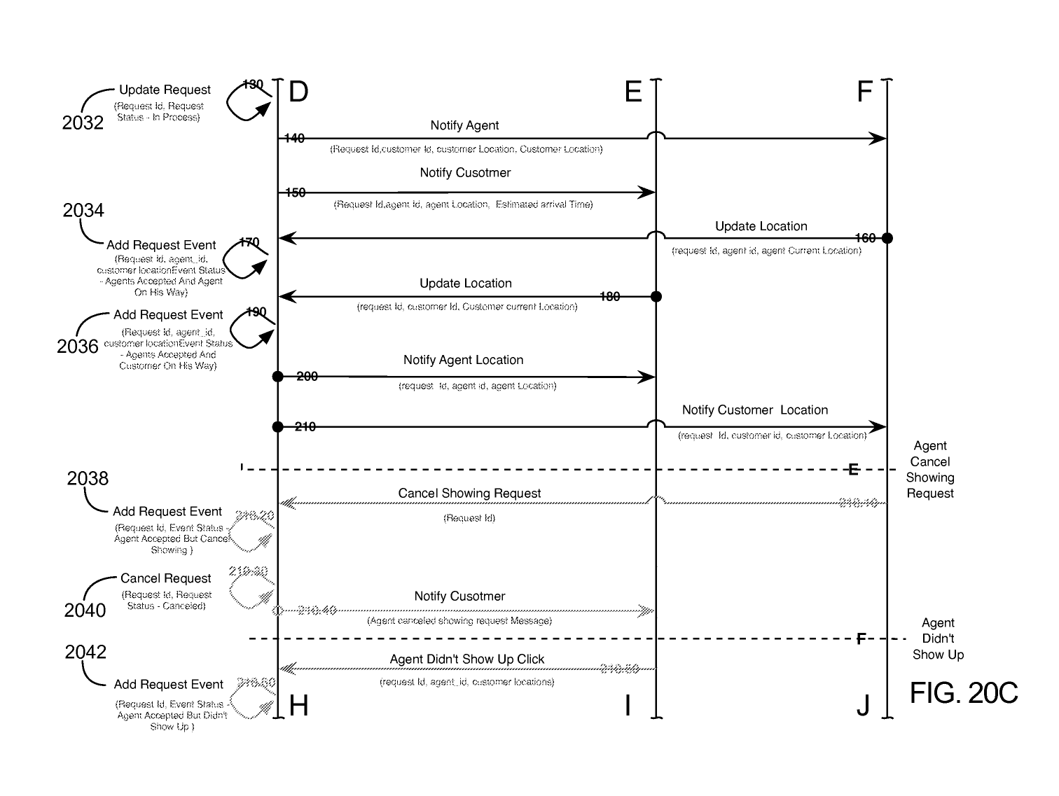

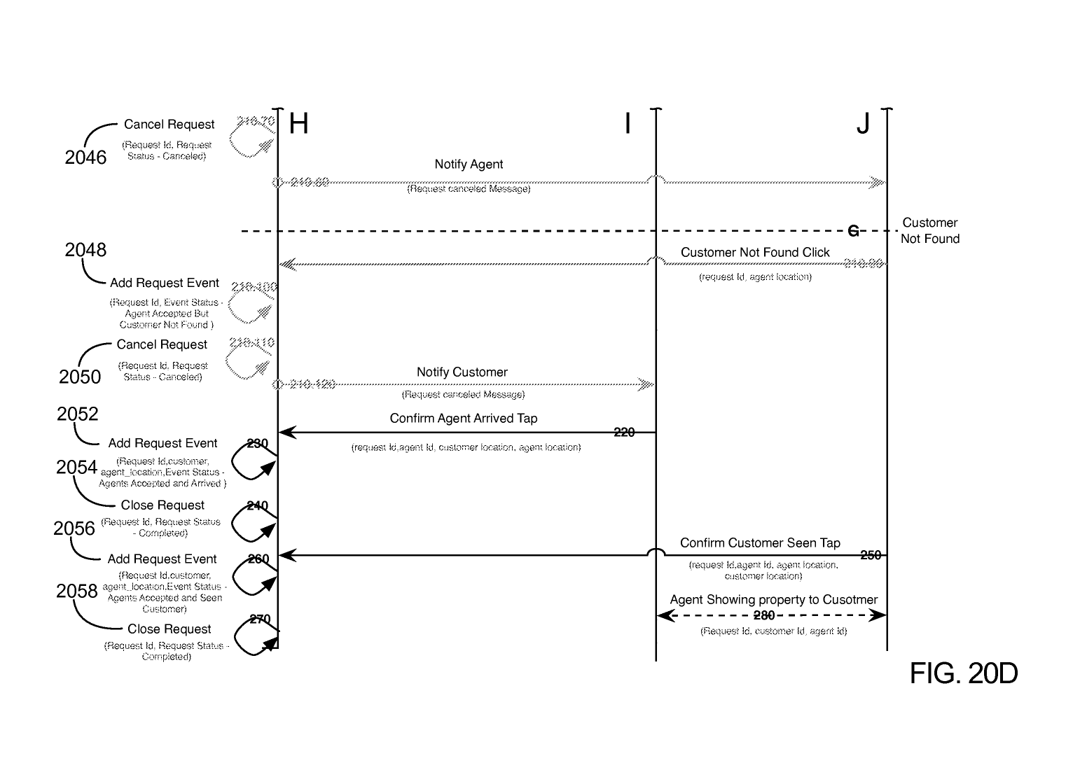

FIGS. 20A-D illustrate a sequence diagram for implementing a method according to this disclosure. The sequence 2000 for software application can be a plurality of events communicated between a server 2002, a customer application 2004, and an agent application 2006.

The server 2002 can be configured to maintain all user information, request data, and provide basic functions such as registration, login information, analytics, configuration, and settings. The server 2002 can also maintain a record of all user's device details and location information. The server 2002 can be configured to communicate with the customer application 2004 and the agent application 2006 using push notifications. In at least one embodiment, the server 2002 can communicate with Apple's Push Notification or Google's Cloud Message service.

The customer application 2004 can be an application running on a customer's electronic device. The electronic device can be a phone, tablet, laptop, or other electronic device configured to operate the application. In at least one embodiment, the customer application 2004 can be an iOS or Android mobile application. The user can download and install the application and register using their mobile number. The customer application 2004 can allow users to register and login without visiting a separate web portal.

The agent application 2006 can be an application running on a customer's electronic device. The electronic device can be a phone, tablet, laptop, or other electronic device configured to operate the application. In at least one embodiment, the customer application 2006 can be an iOS or Android mobile application. In at least one embodiment, the website is used by Agents for registration and verification of their mobile number and electronic device. The agent can then download the agent application 2006 and login. The agent application can track and periodically update the server 2002 with the agent's location, when properly authorized. In at least one embodiment, the server 2002 can send push notifications about nearby showings and make periodic web service calls to the server 2002 to get the latest information in the event push notifications are not working.

The sequence 2000 can begin with a user initiating an event 2008 for a showing request for a property from the customer application 2004. At event 2010, the server 2002 can then validate the property location and generate a showing request. The property location can be a house or property the customer is interested in. The customer can either input the address for the property, or authorize the application 2004 to access the GPS location of the user's electronic device. The sequence 2000 can then proceed to event 2012 to find agents. Event 2012 can be based on customer location, agent location, and agent availability.

If no agents are available, event 2014 can notify to the user no agents are available. The notification can be a push notification. The user can then choose to cancel the request, event 2016. If an agent is available, the server 2002 can determine a batch of available agents based on their respective locations relative to the property location and send a push notification with the showing request details. The server 2002 can maintain a list of agents to whom the request is sent. The server 2002 waits for any of the agents to accept the request for a predetermined amount of time. If no agent accepts, the server 2002 generates a new batch of next closest agents and sends them a push notification with the showing request details. This process continues until either an agent accepts, all agents within a maximum search radius are contacted, or the request times out and no agents respond. The maximum search radius, number of agents in a batch, and time out interval are determined and configuration settings on the server 2002. If no agents accept, the user is notified of the unavailability of agents using a push notification, event 2014.

The first agent to accept the showing request is sent to the customer, event 2020. Event 2020 can alternatively indicate the agent declines the showing request. If a second agent accepts, the second agent is notified of the unavailability of the request because another agent has already accepted (event 2021). If the agent accepts, event 2022 a notification can be sent to the customer informing about the agent's acceptance along with basic information about the agent. This information can include agent's name, contact details, and profile picture. In at least one embodiment, the agent basic information also includes a video introduction of the realtor to the client. In at least one embodiment, the user can upload an introduction video introducing client to realtor. The client can choose to video in front of the property to be shown. The introduction videos (both agent and user) can be transmitted within the application, via email, text message, or other available method.

After notification, the sequence 2000 can proceed to event 2024 where the customer 2004 is prompted to confirm the agent or reject and opt to find another agent for the same property. The customer can decline the agent, event 2026, or the customer can cancel the request, event 2028. If the customer opts to find another agent, the agent is notified an a new showing request with the same customer and property information is initiated. The rejected agent is not included while searching for agents with this new request. Optionally, the sequence 2000 can return to 2010 to initiate a new showing request.

Alternatively, the customer 2004 can confirm the agent, event 2030. If the customer accepts the agent, event 2032 notifies the agent. Following notification, an event 2034 indicates the agent is on his way to the requested location. A similar event 2036 can indicate the customer is on his way. Events 2034 and 2036 can update periodically with currently locations and both the customer and agent applications 2004, 2006 are notified with updated statuses. After confirmations, the agent is expected to proceed to the property location, meet the customer, and show the property. Either party can cancel the request at any point.

If the agent cancels, event 2038 indicates the customer being notified of the request cancellation. The customer can opt to find another agent to show the property, returning the sequence 2000 to event 2010. Event 2040 can indicate the notification to the customer that the agent has canceled the request. If the agent does not show up at the property, the customer can indicate the agent did not show up for the showing without canceling. The customer can report that the agent did not show up at event 2042. At event 2046, the request for a showing is cancelled.

As shown, a cancellation message can be sent from the server 2002 to the agent's electronic device. At event 2048, an additional event is requested. In 2048, a message can be sent from the agent's electronic device to the server 2002 requesting information about the event status. The request can seek event identification. The event can be an indication that the agent has accepted the customer's request for a showing, but that the requesting customer cannot be located. At event 2050, the server 2002 notifies the customer's electronic device that the request in question has been cancelled.

The customer can report from the customer's application 2004 to the server 2002 indicating that the realtor has arrived to provide the requested showing. The server 2002 can then log all the data for analytics and close the showing request, 2054, 2056, 2058. The agent can send a message to the server 2002 to confirm that the customer has been met by the agent. The agent shows the requested property to the customer and the customer's request for a showing can be closed.

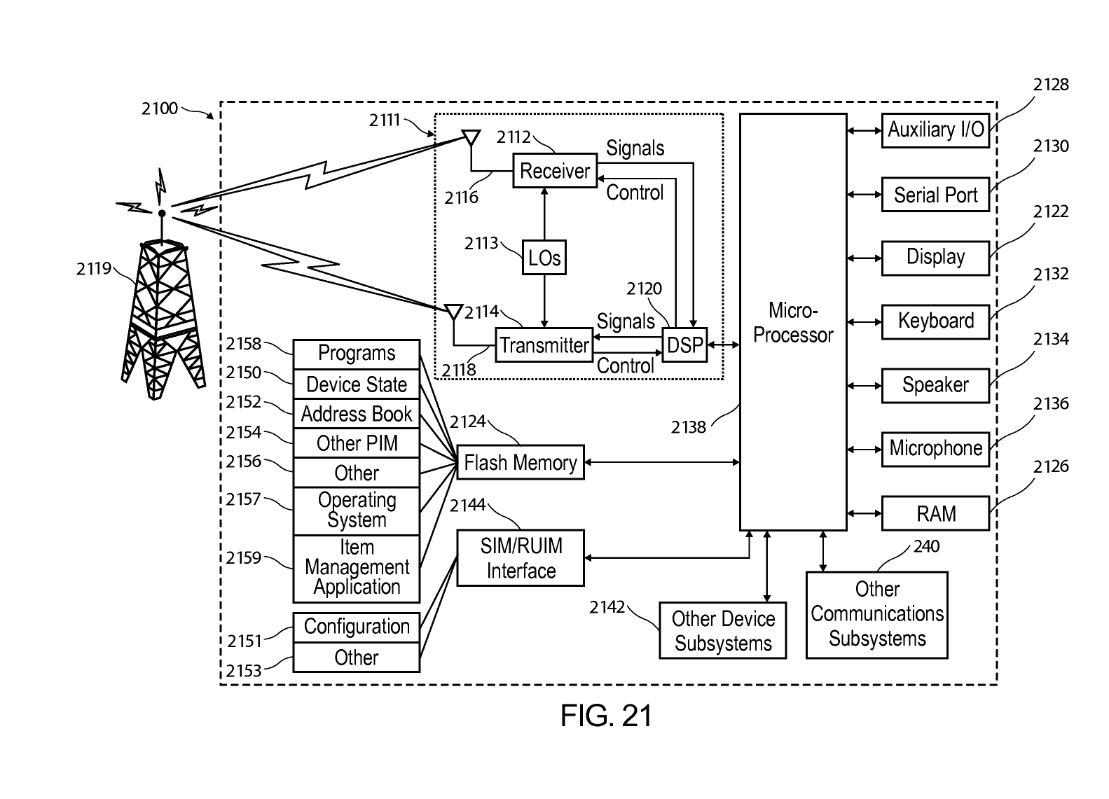

Referring to FIG. 21, a block diagram of an electronic device in accordance with an exemplary implementation is illustrated. As shown, the electronic device 2100 includes a microprocessor 2138 that controls the operation of the electronic device 2100. A communication subsystem 2111 performs all communication transmission and reception with the wireless network 2119. The microprocessor 2138 further can be communicatively coupled with an auxiliary input/output (I/O) subsystem 2128 which can be communicatively coupled to the electronic device 2100. Additionally, in at least one implementation, the microprocessor 2138 can be communicatively coupled to a serial port (for example, a Universal Serial Bus port) 2130 which can allow for communication with other devices or systems via the serial port 2130. A display 2122 can be communicatively coupled to microprocessor 2138 to allow for displaying of information to an operator of the electronic device 2100. When the electronic device 2100 is equipped with the keyboard 2132, the keyboard can also be communicatively coupled with the microprocessor 2138. The electronic device 2100 can include a speaker 2134, a microphone, 2136, random access memory (RAM) 2126, and flash memory 2124, all of which can be communicatively coupled to the microprocessor 2138. Other similar components can be provided on the electronic device 2100 as well and optionally communicatively coupled to the microprocessor 2138. Other communication subsystems 2140 and other electronic device subsystems 2142 are generally indicated as being functionally connected with the microprocessor 2138 as well. An example of a communication subsystem 2140 is that of a short range communication system such as BLUETOOTH® communication module or a WI-FI® communication module (a communication module in compliance with IEEE 802.11b) and associated circuits and components. Additionally, the microprocessor 2138 is able to perform operating system functions and enables execution of programs on the electronic device 2100. In some implementations not all of the above components can be included in the electronic device 2100. For example, in at least one implementation, the keyboard 2132 is not provided as a separate component and is instead integrated with a touchscreen as described below.

Furthermore, the electronic device 2100 is equipped with components to enable operation of various programs, as shown in FIG. 21. In an exemplary implementation, the flash memory 2124 is enabled to provide a storage location for the operating system 2157, device programs 2158, and data. The operating system 2157 is generally configured to manage other programs 2158 that are also stored in memory 2124 and executable on the microprocessor 2138. The operating system 2157 honors requests for services made by programs 2158 through predefined program 2158 interfaces. More specifically, the operating system 2157 typically determines the order in which multiple programs 2158 are executed on the microprocessor 2138 and the execution time allotted for each program 2158, manages the sharing of memory 2124 among multiple programs 2158, handles input and output to and from other device subsystems 2142, and so on. In addition, operators can typically interact directly with the operating system 2157 through a user interface usually including the keyboard 2132 and display screen 2122. While in an exemplary implementation the operating system 2157 is stored in flash memory 2124, the operating system 2157 in other implementations is stored in read-only memory (ROM) or similar storage element (not shown). As those skilled in the art will appreciate, the operating system 2157, device program 2158 or parts thereof can be loaded in RAM 2126 or other volatile memory.

When the electronic device 2100 is enabled for two-way communication within the wireless communication network 21119, the electronic device 2100 can send and receive signals from a mobile communication service. Examples of communication systems enabled for two-way communication include, but are not limited to, the General Packet Radio Service (GPRS) network, the Universal Mobile Telecommunication Service (UMTS) network, the Enhanced Data for Global Evolution (EDGE) network, the Code Division Multiple Access (CDMA) network, High-Speed Packet Access (HSPA) networks, Universal Mobile Telecommunication Service Time Division Duplexing (UMTS-TDD), Ultra Mobile Broadband (UMB) networks, Worldwide Interoperability for Microwave Access (WiMAX), and other networks that can be used for data and voice, or just data or voice. For the systems listed above, the electronic device 2100 can use a unique identifier to enable the electronic device 2100 to transmit and receive signals from the communication network 21119. Other systems can operate without such identifying information. GPRS, UMTS, and EDGE use a smart card such as a Subscriber Identity Module (SIM) in order to allow communication with the communication network 21119 Likewise, most CDMA systems use a Removable User Identity Module (RUIM) in order to communicate with the CDMA network. A smart card can be used in multiple different electronic devices 2100. The electronic device 2100 can perform some operations without a smart card, but the electronic device 2100 cannot be able to communicate with the network 21119. A smart card interface 2144 located within the electronic device 2100 allows for removal or insertion of a smart card (not shown). The smart card features memory and holds key configurations 2151, and other information 2153 such as identification and subscriber related information. With a properly enabled electronic device 2100, two-way communication between the electronic device 2100 and communication network 21119 is possible.

If the electronic device 2100 is enabled as described above or the communication network 21119 does not require such enablement, the two-way communication enabled electronic device 2100 is able to both transmit and receive information from the communication network 21119. The transfer of communication can be from the electronic device 2100 or to the electronic device 2100. In order to communicate with the communication network 21119, the electronic device 2100 in the presently described exemplary implementation is equipped with an integral or internal antenna 2118 for transmitting signals to the communication network 21119. Likewise the electronic device 2100 in the presently described exemplary implementation is equipped with another antenna 2116 for receiving communication from the communication network 21119. These antennae (2116, 2118) in another exemplary implementation are combined into a single antenna (not shown). As one skilled in the art would appreciate, the antenna or antennae (2116, 2118) in another implementation are externally mounted on the electronic device 2100.

When equipped for two-way communication, the electronic device 2100 features the communication subsystem 2111. As is understood in the art, the communication subsystem 2111 is modified so that the communication subsystem 2111 can support the operational needs of the electronic device 2100. The subsystem 2111 includes a transmitter 2114 and receiver 2112 including the associated antenna or antennae (2116, 2118) as described above, local oscillators (LOs) 2113, and a processing module 2120, which in the presently described exemplary implementation is a digital signal processor (DSP) 2120.

Communication by the electronic device 2100 with the wireless network 21119 can be any type of communication that both the wireless network 21119 and electronic device 2100 are enabled to transmit, receive and process. In general, the communication can be classified as voice and data. Voice communication generally refers to communication in which signals for audible sounds are transmitted by the electronic device 2100 through the communication network 21119. Data generally refers to all other types of communication that the electronic device 2100 is capable of performing within the constraints of the wireless network 21119.

The keyboard 2132 can include a plurality of keys that can be of a physical nature such as actuable buttons, or the plurality of keys can be of a software nature, typically constituted by virtual representations of physical keys on the display screen 2122 (referred to herein as “virtual keys”). The user input can be provided as a combination of the two types of keys. Each key of the plurality of keys can have at least one actuable action which can be the input of indicia such as a character, a command or a function. “Characters” are contemplated to exemplarily include alphabetic letters, language symbols, numbers, punctuation, insignias, icons, pictures, and even a blank space.

In the case of virtual keys, the indicia for the respective keys are shown on the display screen 2122, which in one implementation is enabled by touching the display screen 2122, for example, with a stylus, finger, or other pointer, to generate the character or activate the indicated command or function. Some examples of display screens 2122 capable of detecting a touch include resistive, capacitive, projected capacitive, infrared and surface acoustic wave (SAW) touchscreens.

Physical and virtual keys can be combined in many different ways as appreciated by those skilled in the art. In one implementation, physical and virtual keys are combined such that the plurality of enabled keys for a particular program or feature of the electronic device 2100 is shown on the display screen 2122 in the same configuration as the physical keys. Using the configuration just described, the operator can select the appropriate physical key corresponding to what is shown on the display screen 2122. Thus, the desired character, command or function is obtained by depressing the physical key corresponding to the character, command or function displayed at a corresponding position on the display screen 2122, rather than touching the display screen 2122.

While the above description generally describes the systems and components associated with a handheld electronic device, the electronic device 2100 could be another electronic device such as a PDA, a laptop computer, desktop computer, a server, or other electronic device. The electronic device 2100 can comprise different components or the above system might be omitted in order to provide the desired electronic device 2100. Additionally, other components not described above can be used to allow the electronic device 2100 to function in a desired fashion. The above description provides only general components and additional components can be used to enable the system to function. The additional systems and components would be appreciated by those of ordinary skill in the art.

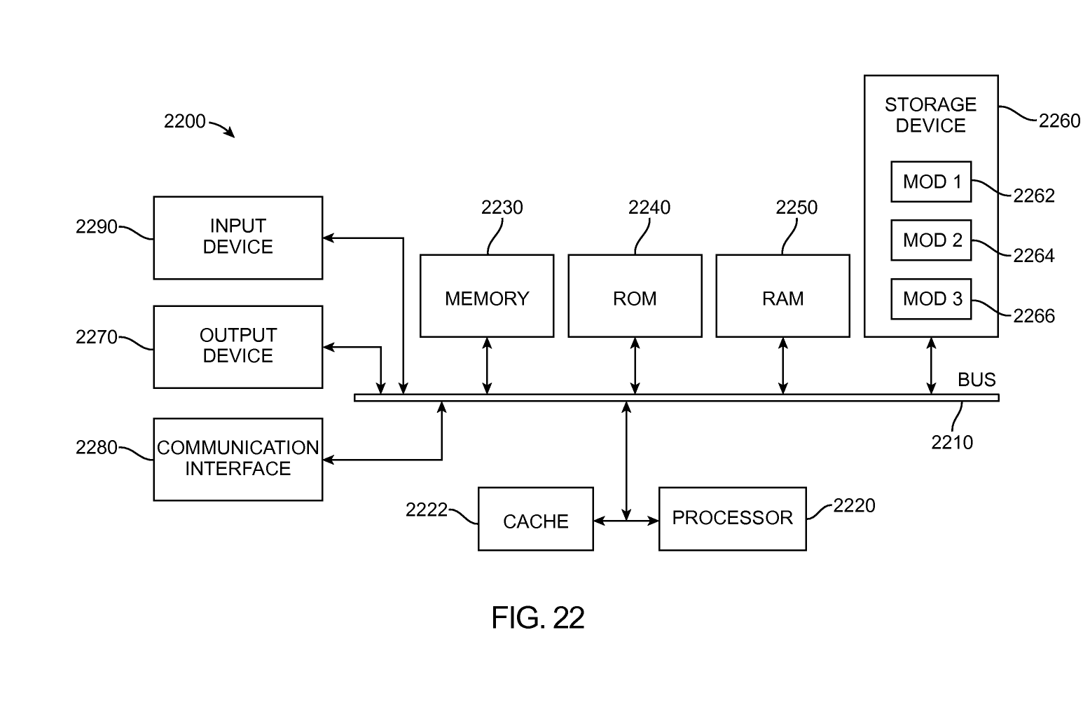

With reference to FIG. 22, an exemplary system and/or control unit 2200 includes a processing unit (for example, a central processing unit (CPU) or processor) 2220 and a system bus 2210 that couples various system components, including the system memory 2230 such as read only memory (ROM) 2240 and random access memory (RAM) 2250, to the processor 2220. The system 2200 can include a cache 2222 of high-speed memory connected directly with, in close proximity to, or integrated as part of the processor 2220. The system 2200 can copy data from the memory 2230 and/or the storage device 2260 to the cache 2222 for access by the processor 2220. These and other modules can control or be configured to control the processor 2220 to perform various operations or actions. The memory 2230 can include multiple different types of memory with different performance characteristics.

Multiple processors or processor cores can share resources such as memory 2230 or the cache 2222, or can operate using independent resources. The processor 2220 can include one or more of a state machine, an application specific integrated circuit (ASIC), or a programmable gate array (PGA) including a field PGA. The system bus 2210 can be any of several types of bus structures including a memory bus or memory controller, a peripheral bus, and a local bus using any of a variety of bus architectures. A basic input/output (BIOS) stored in ROM 2240 or the like, may provide the basic routine that helps to transfer information between elements within the computing device 2200, such as during start-up.

The computing device 2200 can further include storage devices 260 or computer-readable storage media such as a hard disk drive, a magnetic disk drive, an optical disk drive, tape drive, solid-state drive, RAM drive, removable storage devices, a redundant array of inexpensive disks (RAID), hybrid storage device, or the like. The storage device 2260 can include software modules 2262, 2264, 2266 for controlling the processor 2220. The system 2200 can include other hardware or software modules. Although the exemplary embodiment(s) described herein employs the hard disk as storage device 2260, other types of computer-readable storage devices which can store data that are accessible by a computer, such as magnetic cassettes, flash memory cards, digital versatile disks (DVDs), cartridges, random access memories (RAMs) 2250, read only memory (ROM) 2240, a cable containing a bit stream and the like may also be used in the exemplary operating environment. Tangible computer-readable storage media, computer-readable storage devices, or computer-readable memory devices, expressly exclude media such as transitory waves, energy, carrier signals, electromagnetic waves, and signals per se.

The basic components and appropriate variations can be modified depending on the type of device, such as whether the device 2200 is a small, handheld computing device, a desktop computer, or a computer server. When the processor 2220 executes instructions to perform “operations”, the processor 2220 can perform the operations directly and/or facilitate, direct, or cooperate with another device or component to perform the operations.

To enable user interaction with the computing device 2200, an input device 2290 represents any number of input mechanisms, such as a microphone for speech, a touch-sensitive screen for gesture or graphical input, keyboard, mouse, motion input, speech and so forth. An output device 2270 can also be one or more of a number of output mechanisms known to those of skill in the art. In some instances, multimodal systems enable a user to provide multiple types of input to communicate with the computing device 2200. The communications interface 2280 generally governs and manages the user input and system output. There is no restriction on operating on any particular hardware arrangement and therefore the basic hardware depicted may easily be substituted for improved hardware or firmware arrangements as they are developed.

One or more parts of the example computing device 2200, up to and including the entire computing device 2200, can be virtualized. For example, a virtual processor can be a software object that executes according to a particular instruction set, even when a physical processor of the same type as the virtual processor is unavailable.

At least one method is a method of establishing a relationship between a client and a realtor. The method can comprise the following steps: a. receiving a request from a client; b. determining a location of the client making the request; c. locating realtors within a first predetermined distance of the location; d. calculating the proximity of each of the realtors to the location; e. notifying the most proximate realtor of the client's request; f. waiting a predetermined amount of time for an affirmative response from the most proximate realtor; g. determining whether an affirmative response has been received from the most proximate realtor; h. if an affirmative response has been received, notifying the client that the affirmative response has been received and notifying the client of the affirmatively responding realtor's identity; i. if an affirmative response has not been received, notifying the next most proximate realtor of the client's request; j. waiting a predetermined amount of time for an affirmative response from the next most proximate realtor; k. determining whether an affirmative response has been received from the next most proximate realtor; l. if an affirmative response has been received, notifying the client that the affirmative response has been received and notifying the client of the affirmatively responding realtor's identity; m. if an affirmative response has not been received, notifying the next most proximate realtor of the client's request; n. repeating steps j through m until all realtors within the predetermined distance until all the located realtors have been notified and a determination has been as to whether an affirmative response has been received from each.

In at least one embodiment, an electronic device can be used to capture and record information about a given property. Such captured information can include, but is not limited to asking price, square footage, and number of bedrooms. Such captured information can also include, but is not limited to information about schools near the property and crime data/statistics for the neighborhood in which the property is located. In at least one embodiment, a client-user can be enabled to post an opinion about the property, (for example, “Hot” or “Not Hot”). A user can also be enabled to store photographic data or audio data or both pertaining to the property. A user can also be enabled to enter notes about a given property via a textual input mechanism running an application described herein. A user can also be enabled to share information about the property or about an agent via a social network system, such as FACEBOOK™ or PINTEREST™, for example.

In at least one embodiment, agents (e.g., realtors) can be enabled to register to participate within the system. The registration system can use email and/or text message confirmation to encourage registration, which can encourage and enable participation. Registration of users can utilize ecommerce checkout and have an automatically recurring billing cycle. Registration can include requiring users to agree to certain appropriate terms conditions. Registration can include requiring users to execute a service level agreement.

In at least one embodiment, a dashboard can be displayed on a realtor's device. The dashboard can be configured to list any pending requests for showings as described above. The dashboard can also be configured to display a list of the realtor's most recent showings. The dashboard can also include a navigation bar which can link the realtor to various features. At least one feature can be a buyer contact list. Within this feature, once an agent connects with a buyer, the buyers name, preferences and contact info are stored in in the agent's buyer contact list. Agents can directly call, text or email buyers from this list. Agents can see a list of properties shown to each buyer and any notes taken during the showing. At least one feature is the option to prevent the system from sending any showing requests from a specific user to the agent. The dashboard can also be configured to display additional information to the agent. Such additional information can include, but is not limited to, the number of showing requests for a predetermined or agent-user specified area, the number of showing requests within a specific period (for example a week or a month), the total number of showing made or requested for a certain property or certain area, or made and requested for a certain property or certain area. The dashboard can also be configured to display information about the number of showing requests for which a response was not received, for a given location or area within a specific period. The dashboard can also be configured to display the number of showing requests that were made during “off” hours. The dashboard can also be configured to display a list of users of the system. The dashboard can also enable an agent to enter an “unavailable mode” in which showing requests send to the agent are automatically declined. In at least one embodiment, showing requests can be tracked, even when the agent is “unavailable.” In at least one embodiment, the dashboard can be configured not to present showing request notifications during specific periods.

In at least one embodiment, an agent can be enabled to establish an agent profile, in which an agent can input, and cause to be shared, personal information, avatar pictures, Multiple Listing Service (MLS) access information, and other relevant information.

In at least one embodiment, an administrator of a system used by clients and realtors can be enabled to perform various functions and access relevant information. Thus the administrator is provided with the ability to manage key functions of their system. For example, the system can be configured to display usage statistics of selected agents. The system can be configured to add agents manually, thereby circumventing the ecommerce signup process. The system can be configured to enable an administrator to suspend an agent from using the system and can enable an administrator to delete agents from the system entirely. The system can also be configured to display usage statistics of selected agents and to enable the administrator to suspend or delete buyers from the system. The system can also be configured to enable the administrator to establish periods in which a given client or realtor can use the system without paying a fee. The system can also enable the administrator to adjust and amend the algorithms discussed above. The system can also be configured to provide the administrator with information pertaining to buyer activity and agent activity. The system can also include one or more algorithms to evaluate performance and responsiveness of agents. Such algorithms could track information such as, how often agents confirm availability for a showing within a specified period after a showing request has been made, (for example, in the first thirty seconds, sixty seconds). Such algorithms can also track data about the number of agents being notified within a certain period after a showing request has been made, (for example, how many agents, on average, are notified who are within ten minutes of fifteen minutes).

Examples within the scope of the present disclosure may also include tangible and/or non-transitory computer-readable storage media for carrying or having computer-executable instructions or data structures stored thereon. Such non-transitory computer-readable storage media can be any available media that can be accessed by a general purpose or special purpose computer, including the functional design of any special purpose processor as discussed above. By way of example, and not limitation, such non-transitory computer-readable media can include RAM, ROM, EEPROM, CD-ROM or other optical disk storage, magnetic disk storage or other magnetic storage devices, or any other medium which can be used to carry or store desired program code means in the form of computer-executable instructions, data structures, or processor chip design. When information is transferred or provided over a network or another communications connection (either hardwired, wireless, or combination thereof) to a computer, the computer properly views the connection as a computer-readable medium. Thus, any such connection is properly termed a computer-readable medium. Combinations of the above should also be included within the scope of the computer-readable media.

Computer-executable instructions include, for example, instructions and data which cause a general purpose computer, special purpose computer, or special purpose processing device to perform a certain function or group of functions. Computer-executable instructions also include program modules that are executed by computers in stand-alone or network environments. Generally, program modules include routines, programs, components, data structures, objects, and the functions inherent in the design of special-purpose processors, etc. that perform particular tasks or implement particular abstract data types. Computer-executable instructions, associated data structures, and program modules represent examples of the program code means for executing steps of the methods disclosed herein. The particular sequence of such executable instructions or associated data structures represents examples of corresponding acts for implementing the functions described in such steps.

Other examples of the disclosure may be practiced in network computing environments with many types of computer system configurations, including personal computers, hand-held devices, multi-processor systems, microprocessor-based or programmable consumer electronics, network PCs, minicomputers, mainframe computers, and the like. Examples may also be practiced in distributed computing environments where tasks are performed by local and remote processing devices that are linked (either by hardwired links, wireless links, or by a combination thereof) through a communications network. In a distributed computing environment, program modules may be located in both local and remote memory storage devices.

In at least one embodiment, an application can include an MLS system for buyers having a direct interface with accurate information. The buyer's MLS can track a buyers interest in particular features of a specific property. This information can include the number of bedrooms, bathrooms, price, square footage, lot size, location, pool, school ratings, price per square foot, number of floors, or other property features. In at least one embodiment, an electronic device can acquire this information from web pages. In another embodiment, an electronic device can grab the screen and send it to a server to process and retrieve the information. The server can then send the retrieved information can back to the electronic device.

In at least one embodiment, an application can include an MLS system for buyers having a direct interface with accurate information. The buyer's MLS can track a property's specifications. This information can include the number of bedrooms, bathrooms, price, square footage, lot size, location, pool, school ratings, price per square foot, number of floors, or other property features. In at least one embodiment, an electronic device can acquire this information from web pages. In another embodiment, an electronic device can grab the screen and send it to a server to process and retrieve the information. The server can then send the retrieved information can back to the electronic device.

The application can allow users to create a virtual fence or boundary about a particular area that they are interested in. The application can inform a user of new listings, sales that have closed, rentals, foreclosures, etc. within the specified area. The application can also alert users to price changes within the area. In at least one embodiment, the application can include a photograph of the property in the alert. The application can further allow a user to request an agent to meet them at the property in response to the specific alert. In at least one embodiment, the request for an agent to meet at the property is an existing relationship with an agent. In other embodiments, the request for an agent to meet at the property is a new relationship.

The agent application 2006 and the customer application 2004 can further include built in mortgage calculators. The mortgage calculators can provide approximate mortgage payment calculations and property insurance approximations. These calculations can assist a client with budgeting, purchase price, and whether they would like to make an offer on a property. The mortgage calculator can generate a contract offer and send them via e-mail or other delivery means (for example ‘Docusign’) whereby the client can immediately attach and electronic signature via their electronic device. In at least one embodiment, an application can download appropriate forms, such as state promulgated forms, for completion by an agent. Completed forms can then be transferred to the client for signature and/or execution, and the signed and/or executed forms can be forwarded to the listing agent, thus enabling the client to make an offer to purchase the property in question immediately.

The agent application 2006 can include a gift or reward button. The button can allow a realtor send a predetermined gift to a client (user) upon completion of a deal. The predetermined gift can be ordered from a predetermined vendor arranged by the application or the realtor. In at least one embodiment, the predetermined gift can be a fruit basket or flowers. The predetermined vendor can have a thank you card on file with a predetermined message and the agent's signature. The agent application 2006 can also send the predetermined vendor the address for the location where the property is located.

The agent application 2006 can further include a re-initialize contact feature. This feature can remind an agent to contact a client after a predetermined period without contact. In at least one embodiment, re-initialize contact feature can prompt an agent to contact a client after a 30 day quiet period. The application 2006 can integrate with a calendar on the electronic device to automatically include and schedule these reminders.

The application can include a referral system allowing agents to communicate with each other. The application can aggregate contact information for the agents allowing each to communicate with the other. This feature can allow a realtor to message another realtor about a specific client, or refer them to a client in the event of a scheduling conflict or similar event. Additionally, the application can allow a client, using the customer application 2004, to refer a friend to a particular agent. In this arrangement, the friend can bypass locating an agent and skip straight to the referred agent.

The various embodiments described above are provided by way of illustration only and should not be construed to limit the scope of the disclosure. Various modifications and changes may be made to the principles described herein without following the example embodiments and applications illustrated and described herein, without departing from the scope of the disclosure.

Along with the claims, other clauses are also possible. These include:

AA. A method of establishing a relationship between a client and a realtor, the method comprising:

a. receiving a request from a client;

b. determining a location of the client making the request;

c. locating realtors within a first predetermined distance of the location;

d. calculating the proximity of each of the realtors to the location;

e. notifying the most proximate realtor of the client's request;

f. waiting a predetermined amount of time for an affirmative response from the most proximate realtor;

g. determining whether an affirmative response has been received from the most proximate realtor;

h. if an affirmative response has been received, notifying the client that the affirmative response has been received and notifying the client of the affirmatively responding realtor's identity;

i. if an affirmative response has not been received, notifying the next most proximate realtor of the client's request;

j. waiting a predetermined amount of time for an affirmative response from the next most proximate realtor;

k. determining whether an affirmative response has been received from the next most proximate realtor;

l. if an affirmative response has been received, notifying the client that the affirmative response has been received and notifying the client of the affirmatively responding realtor's identity;

m. if an affirmative response has not been received, notifying the next most proximate realtor of the client's request;

n. repeating j through m until all realtors within the predetermined distance until all the located realtors have been notified and a determination has been as to whether an affirmative response has been received from each.

BB. The method of clause AA, further comprising:

k. if no affirmative response has been received in e through n, locating realtors within a second predetermined distance of the location, while excluding the realtors notified in e through m;

l. calculating the proximity of each of the realtors to the location;

m. notifying the most proximate realtor of the client's request;

n. waiting a predetermined amount of time for an affirmative response from the most proximate realtor;

o. determining whether an affirmative response has been received from the most proximate realtor;

p. if an affirmative response has been received, notifying the client that the affirmative response has been received and notifying the client of the affirmatively responding realtor's identity;

q. if an affirmative response has not been received, notifying the next most proximate realtor of the client's request;

r. waiting a predetermined amount of time for an affirmative response from the next most proximate realtor;

s. determining whether an affirmative response has been received from the next most proximate realtor;

t. if an affirmative response has been received, notifying the client that the affirmative response has been received and notifying the client of the affirmatively responding realtor's identity;

u. if an affirmative response has not been received, notifying the next most proximate realtor of the client's request;

v. repeating r through u until all realtors within the second predetermined distance until all the located realtors have been notified and a determination has been as to whether an affirmative response has been received from each.

CC. The method of clause BB, further comprising: if no affirmative response has been through m through v, increasing the second predetermined distance by a predetermined amount and repeating l through v.

DD. The method of clause BB, further comprising: if no affirmative response has been through m through v, increasing the second predetermined distance by a second predetermined amount and repeating l through v.

EE. The method of clause BB, further comprising: if no affirmative response has been through m through v, increasing the second predetermined distance by a third predetermined amount and repeating l through v.

FF. The method of clause BB, further comprising: if no affirmative response has been through m through v, increasing the second predetermined distance by a second predetermined amount and repeating l through v.

GG. The method of any one of clauses AA-FF, wherein the client is provided with the opportunity to prevent at least one located realtor from being notified.

HH. A system for establishing a relationship between a client and a realtor, the system comprising: at least one non-transitory computer-readable medium storing instructions; at least one processor coupled to the at least one non-transitory computer-readable medium, the processor configured to, upon execution of the instructions to:

a. receive a request from a client;

b. determine a location of the client making the request;

c. locate realtors within a first predetermined distance of the location;

d. calculate the proximity of each of the realtors to the location;

e. notify the most proximate realtor of the client's request;

f. wait a predetermined amount of time for an affirmative response from the most proximate realtor;

g. determine whether an affirmative response has been received from the most proximate realtor;

h. if an affirmative response has been received, notify the client that the affirmative response has been received and notifying the client of the affirmatively responding realtor's identity;

i. if an affirmative response has not been received, notify the next most proximate realtor of the client's request;

j. wait a predetermined amount of time for an affirmative response from the next most proximate realtor;

k. determine whether an affirmative response has been received from the next most proximate realtor;

l. if an affirmative response has been received, notify the client that the affirmative response has been received and notifying the client of the affirmatively responding realtor's identity;

m. if an affirmative response has not been received, notify the next most proximate realtor of the client's request;

n. repeat j through m until all realtors within the predetermined distance until all the located realtors have been notified and a determination has been as to whether an affirmative response has been received from each.

II. An electronic device for establishing a relationship between a client and a realtor, the electronic device comprising: at least one non-transitory computer-readable medium storing instructions; at least one processor coupled to the at least one non-transitory computer-readable medium, the processor configured to, upon execution of the instructions to:

a. receive a request from a client at an input portion of the electronic device;

b. determine a location of the client making the request;

c. locate realtors within a first predetermined distance of the location;

d. calculate the proximity of each of the realtors to the location;

e. notify the most proximate realtor of the client's request;

f. wait a predetermined amount of time for an affirmative response from the most proximate realtor;

g. determine whether an affirmative response has been received from the most proximate realtor;

h. if an affirmative response has been received, notify the client that the affirmative response has been received and notifying the client of the affirmatively responding realtor's identity;

i. if an affirmative response has not been received, notify the next most proximate realtor of the client's request;

j. wait a predetermined amount of time for an affirmative response from the next most proximate realtor;

k. determine whether an affirmative response has been received from the next most proximate realtor;

l. if an affirmative response has been received, notify the client that the affirmative response has been received and notifying the client of the affirmatively responding realtor's identity;

m. if an affirmative response has not been received, notify the next most proximate realtor of the client's request;

n. repeat j through m until all realtors within the predetermined distance until all the located realtors have been notified and a determination has been as to whether an affirmative response has been received from each.

Code suitable for execution by an electronic device within this disclosure is shown below:

What is claimed is:

1. A system comprising:
at least one processor, at least one non-transitory computer readable medium in communication with the processor;
at least one program module, stored on the at least one medium, and operative upon execution by the processor to cause the processor to:
receive, from an electronic device associated with a user, a viewing request for a showing of a listed property;
identify one or more agents within a predetermined distance of the showing;
send a showing request to at least one of the identified agents;
receive an acceptance of the showing request from at least one of the identified agents; and
send a time estimate to the electronic device.

2. The system as recited in claim 1, wherein the program module is further operative to cause the processor to retrieve global positioning system (GPS) information corresponding to the requested listing and send the GPS information to the at least one of the identified agents.

3. The system as recited in claim 1, wherein the program module is further operative to cause the processor to compare the requested listing with other listings stored in a database of listings and send similar listings to the electronic device.

4. The system as recited in claim 1, wherein the program module is further operative to cause the processor to retrieve GPS data corresponding to the identified one or more agents and send the GPS data to the electronic device.

5. The system of claim 1, wherein sending a showing request includes at least one of photographic and address information corresponding to the listing.

6. The system as recited in claim 1, wherein the program module is further operative to receive at least one additional acceptance of the showing request and determine which of the acceptances should be transmitted to the electronic device.

7. The system of claim 1, wherein the time estimate is one of travel time from the agent providing the acceptance to the showing.

8. The system of claim 7, wherein the time estimate is estimated based on distance.

9. The system of claim 7, wherein the time estimate is estimated based on traffic congestion.

10. A computer program product comprising:
at least one non-transitory computer readable medium;
at least one program module, stored on the at least one medium, and operative upon execution by at least one processor to cause the processor to:
receive, from an electronic device associated with a user, a viewing request for a showing of a listed property;
identify one or more agents within a predetermined distance of the showing;
send a showing request to at least one of the identified agents;
receive an acceptance of the showing request from at least one of the identified agents; and
send a time estimate to the electronic device.

11. The computer program product as recited in claim 10, wherein the program module is further operative to cause the processor to retrieve global positioning system (GPS) information corresponding to the requested listing and send the GPS information to the at least one of the identified agents.

12. The computer program product as recited in claim 10, wherein the program module is further operative to cause the processor to compare the requested listing with other listings stored in a database of listings and send similar listings to the electronic device.

13. The computer program product as recited in claim 10, wherein the program module is further operative to cause the processor to retrieve GPS data corresponding to the identified one or more agents and send the GPS data to the electronic device.

14. The computer program product of claim 10, wherein sending a showing request includes at least one of photographic and address information corresponding to the listing.

15. The computer program product as recited in claim 10, wherein the program module is further operative to receive at least one additional acceptance of the showing request and determine which of the acceptances should be transmitted to the electronic device.

16. The computer program product of claim 10, wherein the time estimate is one of travel time from the agent providing the acceptance to the showing.

17. The computer program product of claim 16, wherein the time estimate is estimated based on distance.

18. The computer program product of claim 16, wherein the time estimate is estimated based on traffic congestion.
